(19) United States
(12) Patent Application Publication
(10) Pub. No.: US 2026/0213642 A1
(43) Pub. Date: Jul. 23, 2026

(54) LLC CONVERTER CONTROL CIRCUIT AND LLC CONVERTER

(71) Applicant: SANKEN ELECTRIC CO., LTD., Niiza-Shi (JP)

(72) Inventor: Shinji ASO, Niiza-Shi (JP)

(73) Assignee: SANKEN ELECTRIC CO., LTD., Niiza-Shi (JP)

(21) Appl. No.: 19/449,623

(22) Filed: Jan. 15, 2026

(30) Foreign Application Priority Data
Jan. 21, 2025 (JP) 2025-008595

(51) Int. Cl. H02M 1/08; H02M 1/00; H02M 1/088; H02M 3/00; H02M 3/335

(52) U.S. Cl. CPC H02M 1/083; H02M 1/0009; H02M 1/0032; H02M 1/088; H02M 3/01; H02M 3/33515

(57) ABSTRACT

An LLC converter control circuit includes a current detection circuit, a synchronization signal generation circuit, a ramp voltage generation circuit, a feedback voltage generation circuit, a comparator circuit, and a driving signal generation circuit. The current detection circuit outputs a current detection result signal. The synchronization signal generation circuit generates a first signal, based on a first driving signal and the current detection result signal. The ramp voltage generation circuit generates a sawtooth ramp voltage. The feedback voltage generation circuit converts a feedback current into a feedback voltage and outputs the feedback voltage. The comparator circuit generates a second signal by performing a comparison between the feedback voltage and the sawtooth ramp voltage. The driving signal generation circuit generates first and second driving signals. The ramp voltage generation circuit generates the sawtooth ramp voltage to allow an amplitude of the sawtooth ramp voltage to decrease as a resonant current decreases.

### CROSS-REFERENCE TO RELATED APPLICATIONS

The present application claims priority from Japanese Patent Application No. 2025-008595 filed on Jan. 21, 2025, the entire contents of which are hereby incorporated by reference.

### BACKGROUND

The disclosure relates to an LLC converter control circuit and an LLC converter.

Techniques have been proposed in regard to a controller for a switching circuit for use in an LLC converter. For example, Japanese Unexamined Patent Application Publication (JP-A) No. 2011-083186 discloses a control device for resonant converters. The control device for the resonant converters disclosed in JP-A No. 2011-083186 performs charging and discharging of a capacitor with a feedback current and controls a half bridge of an LLC converter, based on respective times of the charging and the discharging.

### SUMMARY

An LLC converter control circuit according to one embodiment of the disclosure is a control circuit for an LLC converter, and is configured to control a high side driving signal and a low side driving signal, based on a resonant current flowing through a resonant circuit configured to resonate through alternate turning-on and turning-off of a high side switch and a low side switch. The high side driving signal is adapted to drive the high side switch. The low side driving signal is adapted to drive the low side switch. The LLC converter control circuit includes a current detection circuit, a synchronization signal generation circuit, a ramp voltage generation circuit, a feedback voltage generation circuit, a comparator circuit, and a driving signal generation circuit. The current detection circuit is configured to perform detection of a current value of the resonant current and output a result of the detection as a current detection result signal. The synchronization signal generation circuit is configured to generate a first signal, based on a first driving signal and the current detection result signal. The first driving signal is adapted to generate the high side driving signal. The ramp voltage generation circuit is configured to generate, based on the first signal, a sawtooth ramp voltage having a slope determined in advance. The feedback voltage generation circuit is configured to convert a feedback current of the LLC converter into a feedback voltage and output the feedback voltage. The comparator circuit is configured to generate a second signal by performing a comparison between the feedback voltage and the sawtooth ramp voltage. The driving signal generation circuit is configured to generate the first driving signal and a second driving signal, based on the second signal. The second driving signal is adapted to generate the low side driving signal. The ramp voltage generation circuit is configured to generate the sawtooth ramp voltage to allow an amplitude of the sawtooth ramp voltage to decrease as the resonant current decreases.

An LLC converter according to one embodiment of the disclosure includes an LLC converter control circuit, an input power supply, a half bridge circuit, a resonant circuit, a rectifying and smoothing circuit, an output voltage detection circuit, and a resonant current detection circuit. The half bridge circuit includes a high side switch and a low side switch. The resonant circuit is coupled between an output of the half bridge circuit and a ground, and includes a primary winding of a transformer and a resonant capacitor that are coupled in series to each other. The rectifying and smoothing circuit includes a first diode, a second diode, and an output capacitor, and is configured to rectify and smooth a current flowing through a secondary winding of the transformer. The output voltage detection circuit is configured to detect an output voltage. The resonant current detection circuit is configured to detect a resonant current flowing through the resonant circuit. The LLC converter control circuit is configured to control a high side driving signal and a low side driving signal, based on the resonant current flowing through the resonant circuit. The resonant circuit is configured to resonate through alternate turning-on and turning-off of the high side switch and the low side switch. The high side driving signal is adapted to drive the high side switch. The low side driving signal is adapted to drive the low side switch. The LLC converter control circuit includes a current detection circuit, a synchronization signal generation circuit, a ramp voltage generation circuit, a feedback voltage generation circuit, a comparator circuit, and a driving signal generation circuit. The current detection circuit is configured to perform detection of a current value of the resonant current and output a result of the detection as a current detection result signal. The synchronization signal generation circuit is configured to generate a first signal, based on a first driving signal and the current detection result signal. The first driving signal is adapted to generate the high side driving signal. The ramp voltage generation circuit is configured to generate, based on the first signal, a sawtooth ramp voltage having a slope determined in advance. The feedback voltage generation circuit is configured to convert a feedback current of the LLC converter into a feedback voltage and output the feedback voltage. The comparator circuit is configured to generate a second signal by performing a comparison between the feedback voltage and the sawtooth ramp voltage. The driving signal generation circuit is configured to generate the first driving signal and a second driving signal, based on the second signal. The second driving signal is adapted to generate the low side driving signal. The ramp voltage generation circuit is configured to generate the sawtooth ramp voltage to allow an amplitude of the sawtooth ramp voltage to decrease as the resonant current decreases.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration of an LLC converter according to one example embodiment of the disclosure.

FIG. 2A is a block diagram for describing an LLC converter control circuit according to a comparative example.

FIG. 2B is a circuit diagram for describing the LLC converter control circuit according to the comparative example.

FIG. 3A is a diagram for describing an operation of the LLC converter control circuit according to the comparative example with an output current of 10 A.

FIG. 3B is a diagram for describing an operation of the LLC converter control circuit according to the comparative example with an output current of 0.1 A.

FIG. 4 is a block diagram illustrating a configuration of an LLC converter control circuit according to a first example embodiment of the disclosure.

FIG. 5 is a diagram illustrating a detailed configuration of the LLC converter control circuit according to the first example embodiment of the disclosure.

FIG. 6A is a diagram for describing an operation of the LLC converter control circuit according to the first example embodiment with an output current of 10 A.

FIG. 6B is a diagram for describing an operation of the LLC converter control circuit according to the first example embodiment with an output current of 0.1 A.

FIG. 7 is a block diagram illustrating a configuration of an LLC converter control circuit according to a second example embodiment of the disclosure.

FIG. 8 is a diagram illustrating a detailed configuration of the LLC converter control circuit according to the second example embodiment of the disclosure.

FIG. 9A is a diagram for describing an operation of the LLC converter control circuit according to the second example embodiment with an output current of 10 A.

FIG. 9B is a diagram for describing an operation of the LLC converter control circuit according to the second example embodiment with an output current of 0.1 A.

FIG. 10 is a diagram illustrating a detailed configuration of an LLC converter control circuit according to a third example embodiment of the disclosure.

FIG. 11A is a diagram for describing an operation of the LLC converter control circuit according to the third example embodiment with an output current of 10 A.

FIG. 11B is a diagram for describing an operation of the LLC converter control circuit according to the third example embodiment with an output current of 0.1 A.

FIG. 12 is a diagram illustrating a detailed configuration of an LLC converter control circuit according to a fourth example embodiment of the disclosure.

FIG. 13 is a diagram illustrating a detailed configuration of a modification example of the LLC converter control circuit according to the fourth example embodiment.

FIG. 14 is a diagram illustrating a detailed configuration of a modification example of the LLC converter control circuit according to the fourth example embodiment.

FIG. 15 is a diagram illustrating a detailed configuration of a modification example of the LLC converter control circuit according to the fourth example embodiment.

FIG. 16A is a diagram for describing an operation of the LLC converter control circuit according to the fourth example embodiment with an output current of 10 A.

FIG. 16B is a diagram for describing an operation of the LLC converter control circuit according to the fourth example embodiment with an output current of 0.1 A.

FIG. 17A is a diagram for describing an operation of the LLC converter control circuit according to the third example embodiment during an imbalanced operating condition as a comparative example.

FIG. 17B is a diagram for describing an operation of the LLC converter control circuit according to the fourth example embodiment.

FIG. 18 is a diagram illustrating an example configuration of a delay circuit of the LLC converter control circuit according to the third example embodiment.

FIG. 19A is a diagram for describing the operation of the LLC converter control circuit according to the third example embodiment during the imbalanced operating condition.

FIG. 19B is a diagram for describing the operation of the LLC converter control circuit according to the third example embodiment during the imbalanced operating condition.

FIG. 20 is a diagram illustrating a detailed configuration of an LLC converter control circuit according to a fifth example embodiment of the disclosure.

FIG. 21A is a diagram for describing an operation of the LLC converter control circuit according to the fifth example embodiment with an output current of 10 A.

FIG. 21B is a diagram for describing an operation of the LLC converter control circuit according to the fifth example embodiment with an output current of 0.1 A.

FIG. 22A is a diagram for describing the operation of the LLC converter control circuit according to the third example embodiment during the imbalanced operating condition as a comparative example.

FIG. 22B is a diagram for describing an operation of the LLC converter control circuit according to the fifth example embodiment.

### DETAILED DESCRIPTION

The control device disclosed in JP-A No. 2011-083186 includes a comparator that compares a reference voltage determined in advance and a sawtooth voltage that is based on the capacitor charged with the feedback current. In the control device, when a load current of the LCC converter is low, that is, during a light load condition, a slope of the sawtooth voltage has to be increased by increasing the feedback current. This results in an increase in circuit current for generating the sawtooth voltage.

It is desirable to provide an LLC converter control circuit and an LLC converter that each make it possible to generate an appropriate sawtooth voltage even in a region where an output current is small.

An LLC converter 10 and LLC converter control circuits 100a to 100e according to some example embodiments of the disclosure will be described in detail below with reference to the accompanying drawings. Hereinafter, the LLC converter control circuits 100a to 100e may each be referred to as an “LLC converter control circuit 100” when no particular distinction is necessary. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### Configuration of LLC Converter 10

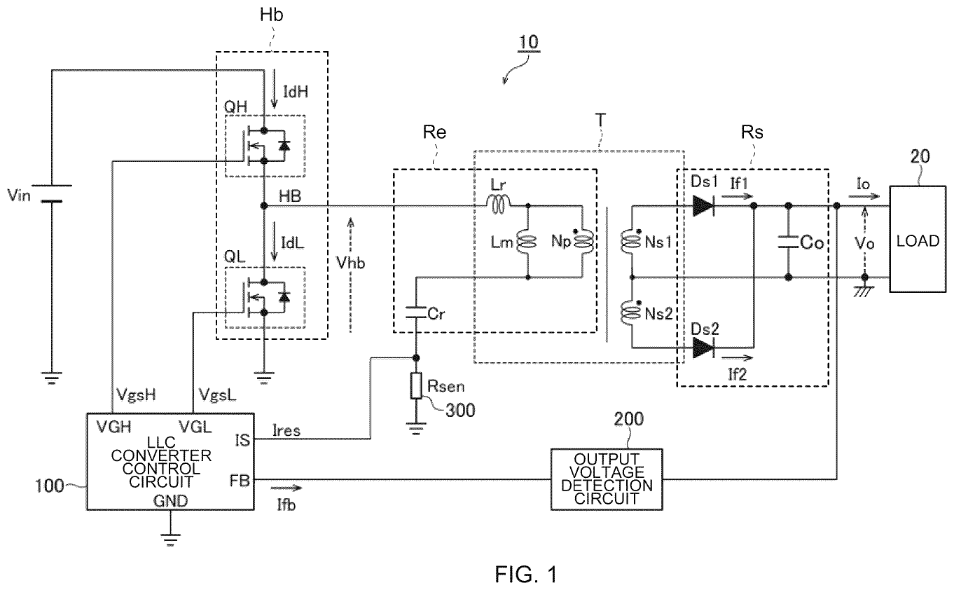

FIG. 1 illustrates a configuration of the LLC converter 10 including the LLC converter control circuit 100 according to an example embodiment of the disclosure.

The LLC converter 10 includes an input power supply Vin, a half bridge circuit Hb, and a resonant circuit Re. The half bridge circuit Hb may be coupled to the input power supply Vin, and includes a high side switch QH and a low side switch QL. The resonant circuit Re is coupled between an output HB of the half bridge circuit Hb and a ground GND. The resonant circuit Re includes a primary winding Np of a transformer T and a resonant capacitor Cr that are coupled in series to each other.

The LLC converter 10 further includes a rectifying and smoothing circuit Rs. The rectifying and smoothing circuit Rs includes a first diode Ds1, a second diode Ds2, and an output capacitor Co, and is configured to rectify and smooth respective currents flowing through secondary windings Ns1 and Ns2 of the transformer T. The LLC converter 10 further includes an output voltage detection circuit 200 configured to detect an output voltage Vo. The LLC converter 10 further includes a resonant current detection circuit 300 configured to detect a resonant current Ires flowing through the resonant circuit Re.

The LLC converter 10 further includes the LLC converter control circuit 100. The LLC converter control circuit 100 may control the high side switch QH and the low side switch QL. The LLC converter control circuit 100 may control a high side driving signal VgsH and a low side driving signal VgsL, based on a feedback current Ifb outputted from the output voltage detection circuit 200 and the resonant current Ires detected by the resonant current detection circuit 300.

The resonant current Ires may be a load current flowing through the resonant circuit Re that resonates through alternate turning-on and turning-off of the high side switch QH and the low side switch QL. The high side driving signal VgsH is adapted to drive the high side switch QH. The low side driving signal VgsL is adapted to drive the low side switch QL. In the LLC converter 10, the output voltage Vo may be controlled based on the high side driving signal VgsH and the low side driving signal VgsL.

### Configuration of LLC Converter Control Circuit 100

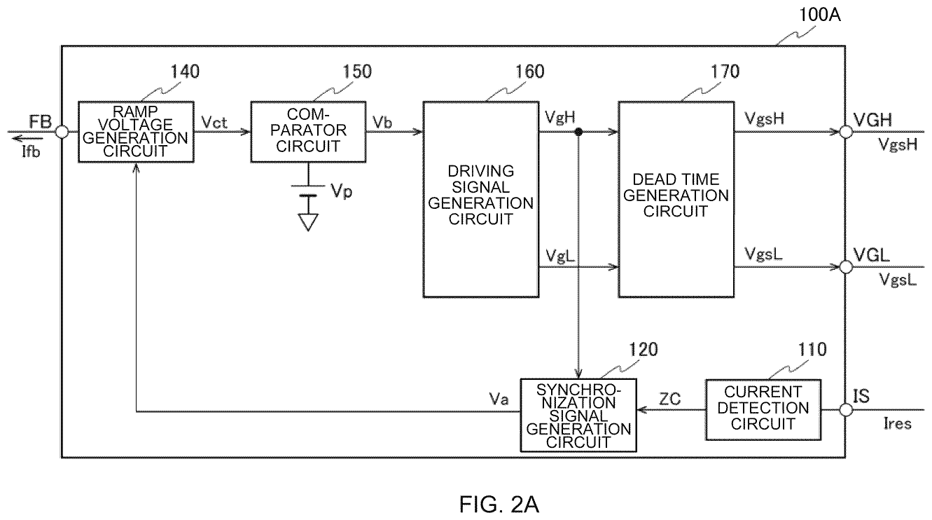

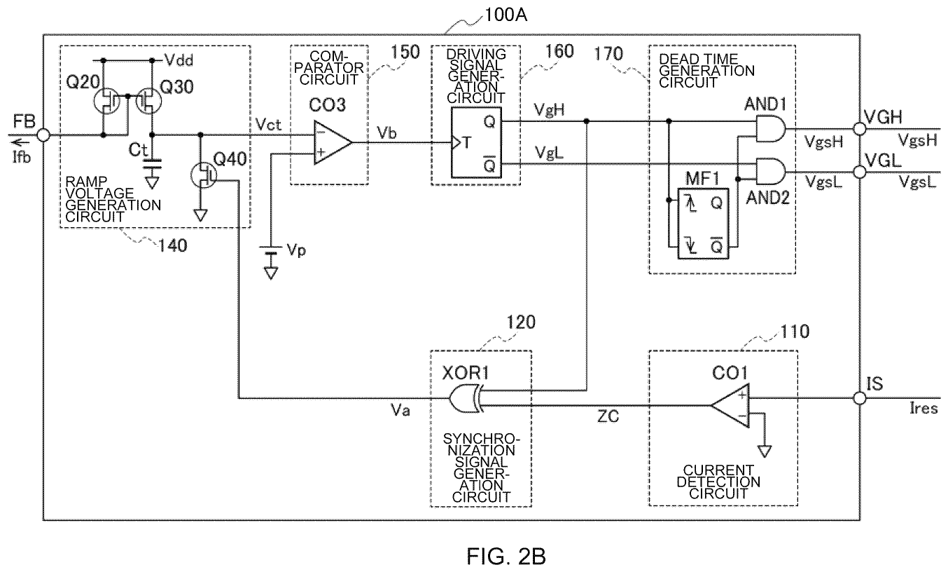

FIGS. 2A and 2B are diagrams for describing an LLC converter control circuit 100A as a comparative example of the LLC converter control circuit 100. The LLC converter control circuit 100A according to the comparative example illustrated in FIGS. 2A and 2B may include a current detection circuit 110, a synchronization signal generation circuit 120, a ramp voltage generation circuit 140, a comparator circuit 150, a driving signal generation circuit 160, and a dead time generation circuit 170.

The current detection circuit 110 performs detection of a current value of the resonant current Ires and outputs a result of the detection as a current detection result signal. The current detection circuit 110 may, for example, compare the resonant current Ires at an IS terminal and a ground (GND) potential, and send out a zero-crossing signal ZC that is to be at a high level (High) when the resonant current Ires is positive, and that is to be at a low level (Low) when the resonant current Ires is negative. In other words, the current detection circuit 110 may compare the resonant current Ires and the GND potential, and output the zero-crossing signal ZC whose voltage level is to change at a timing at which the resonant current Ires switches to a positive value or a negative value. The zero-crossing signal ZC may correspond to a specific but non-limiting example of the “current detection result signal” according to one embodiment of the disclosure.

The synchronization signal generation circuit 120 generates a first signal Va, based on a first driving signal VgH and the current detection result signal. The first driving signal VgH is adapted to generate the high side driving signal VgsH. For example, the synchronization signal generation circuit 120 may input the first driving signal VgH outputted from the driving signal generation circuit 160 and the zero-crossing signal ZC outputted from the current detection circuit 110 to an exclusive OR circuit (a circuit XOR1) to thereby generate the first signal Va.

At a time at which the first signal Va outputted from the synchronization signal generation circuit 120 turns Low, the ramp voltage generation circuit 140 may start charging a capacitor Ct with the feedback current Ifb flowing through an FB terminal. Further, the ramp voltage generation circuit 140 may discharge the capacitor Ct at a timing at which the first signal Va turns High, and may thereby output a ramp voltage Vct.

The comparator circuit 150 may perform a comparison between the ramp voltage Vct and a reference voltage Vp and send out a second signal Vb indicating a result of the comparison. The second signal Vb may turn High when the ramp voltage Vct exceeds the reference voltage Vp.

The driving signal generation circuit 160 may include a toggle flip-flop (T-FF). The T-FF may be configured to receive the second signal Vb, configured to output the first driving signal VgH from a Q output, and configured to output a second driving signal VgL from an NQ output. Further, the driving signal generation circuit 160 may toggle between the first driving signal VgH and the second driving signal VgL at a rising edge (a timing of rising) of the second signal Vb that indicates the result of the comparison performed by the comparator circuit 150.

The dead time generation circuit 170 may generate the high side driving signal VgsH and the low side driving signal VgsL by delaying respective timings of rising of the first driving signal VgH and the second driving signal VgL, and may output the high side driving signal VgsH and the low side driving signal VgsL to a VGH terminal and a VGL terminal, respectively.

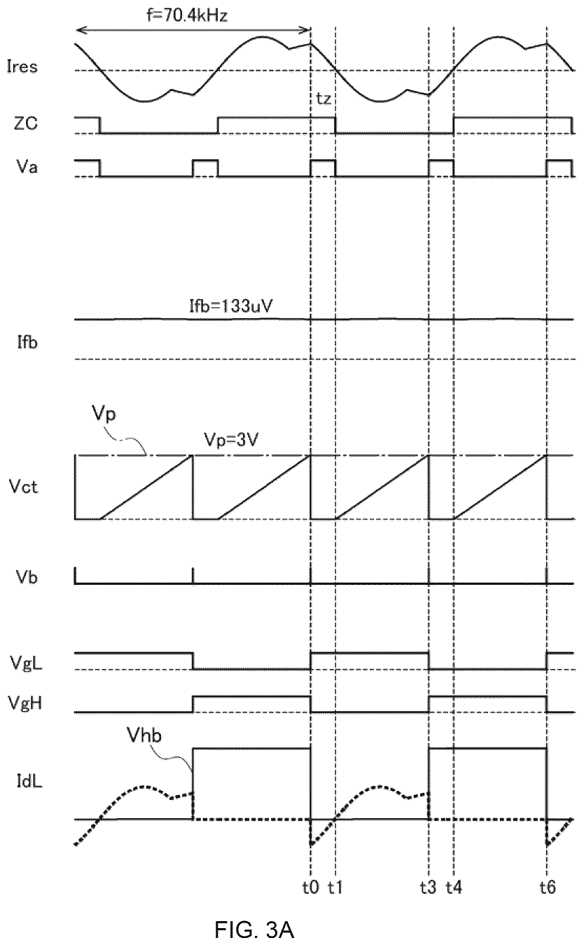

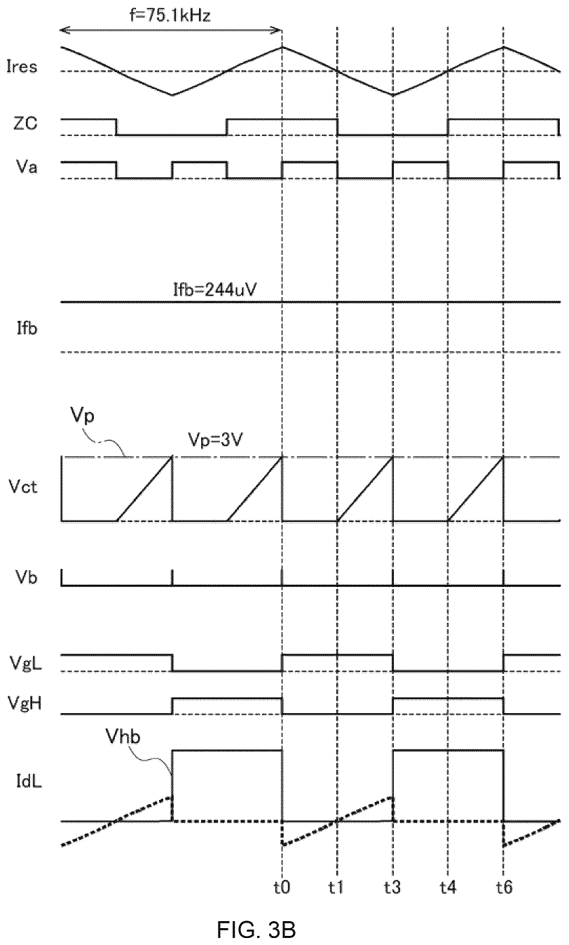

Reference is now made to FIGS. 3A and 3B to describe operations of the LLC converter control circuit 100A according to the comparative example illustrated in FIGS. 2A and 2B. FIG. 3A is a diagram for describing an operation of the LLC converter control circuit 100A according to the comparative example with an output current of 10 A. FIG. 3B is a diagram for describing an operation of the LLC converter control circuit 100A according to the comparative example with an output current of 0.1 A.

At a time t0 in FIGS. 3A and 3B, the resonant current Ires may be positive and the zero-crossing signal ZC may be High. At the time t0, the ramp voltage Vct of the capacitor Ct may become higher than the reference voltage Vp determined in advance. Accordingly, the second signal Vb may turn High, which may cause the first driving signal VgH to turn Low, and cause the second driving signal VgL to turn High.

Due to the first driving signal VgH turning Low, the first signal Va to be outputted from the synchronization signal generation circuit 120 may turn High. When the first signal Va turns High, a transistor Q40 of the ramp voltage generation circuit 140 may turn on and the ramp voltage Vct may be discharged to zero, which may cause the second signal Vb to turn Low.

Thereafter, at a time t1, the resonant current Ires may turn negative, and accordingly, the zero-crossing signal ZC may turn Low from High. When the zero-crossing signal ZC turns Low, the first signal Va to be outputted from the synchronization signal generation circuit 120 may turn Low, due to the first driving signal VgH being Low. When the first signal Va turns Low, the transistor Q40 may turn off.

When the transistor Q40 turns off, the capacitor Ct may start being charged with the feedback current Ifb. The ramp voltage Vct may start rising at the time t1, that is, at a zero-crossing point at which the resonant current Ires turns negative from positive.

At a time t3, the resonant current Ires may be negative and the zero-crossing signal ZC may be Low. Further, at the time t3, the ramp voltage Vct of the capacitor Ct may become higher than the reference voltage Vp determined in advance, and the second signal Vb may thus turn High, which may cause the first driving signal VgH to turn High, and cause the second driving signal VgL to turn Low.

Due to the first driving signal VgH turning High, the first signal Va to be outputted from the synchronization signal generation circuit 120 may turn High. When the first signal Va turns High, the transistor Q40 of the ramp voltage generation circuit 140 may turn on and the ramp voltage Vct may be discharged to zero, which may cause the second signal Vb to turn Low.

At a time t4, the resonant current Ires may turn positive, and accordingly, the zero-crossing signal ZC may turn High from Low. When the zero-crossing signal ZC turns High, the first signal Va to be outputted from the synchronization signal generation circuit 120 may turn Low, due to the first driving signal VgH being High. When the first signal Va turns Low, the transistor Q40 may turn off.

When the transistor Q40 turns off, the capacitor Ct may start being charged with the feedback current Ifb. The ramp voltage Vct may start rising at the time t4, that is, at a zero-crossing point at which the resonant current Ires turns positive from negative.

At a time t6, the resonant current Ires may be positive and the zero-crossing signal ZC may be High. At the time t6, the ramp voltage Vct of the capacitor Ct may become higher than the reference voltage Vp determined in advance, and the second signal Vb may thus turn High, which may cause the first driving signal VgH to turn Low, and cause the second driving signal VgL to turn High.

Due to the first driving signal VgH turning Low, the first signal Va to be outputted from the synchronization signal generation circuit 120 may turn High. When the first signal Va turns High, the transistor Q40 may turn on and the ramp voltage Vct may be discharged to zero, which may cause the second signal Vb to turn Low.

In the LLC converter control circuit 100A according to the comparative example illustrated in FIGS. 2A and 2B, the comparator circuit 150 may perform a comparison between the reference voltage Vp determined in advance and the ramp voltage Vct. Further, charging of the capacitor Ct may be performed with the feedback current Ifb. Because a decrease in the load current can cause a delay in zero crossing, it is necessary that, during a light load condition, the feedback current Ifb be increased to achieve a steeper slope of the ramp voltage Vct. The operation of the LLC converter control circuit 100A according to the comparative example illustrated in FIGS. 2A and 2B can thus involve an increase in circuit current for generating the ramp voltage.

The LLC converter control circuits 100a to 100e according to the example embodiments of the disclosure each help to generate an appropriate sawtooth voltage (ramp voltage Vct) even in a region where the output current is small.

### First Example Embodiment

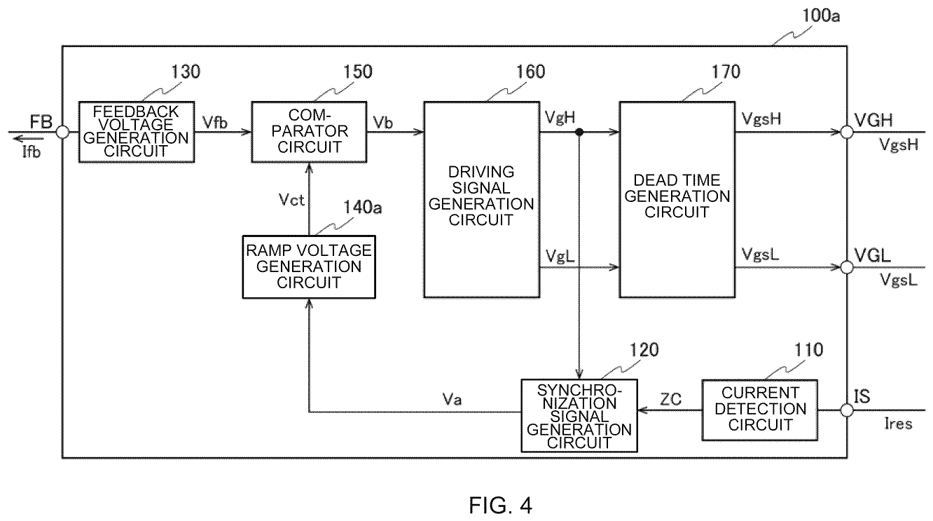

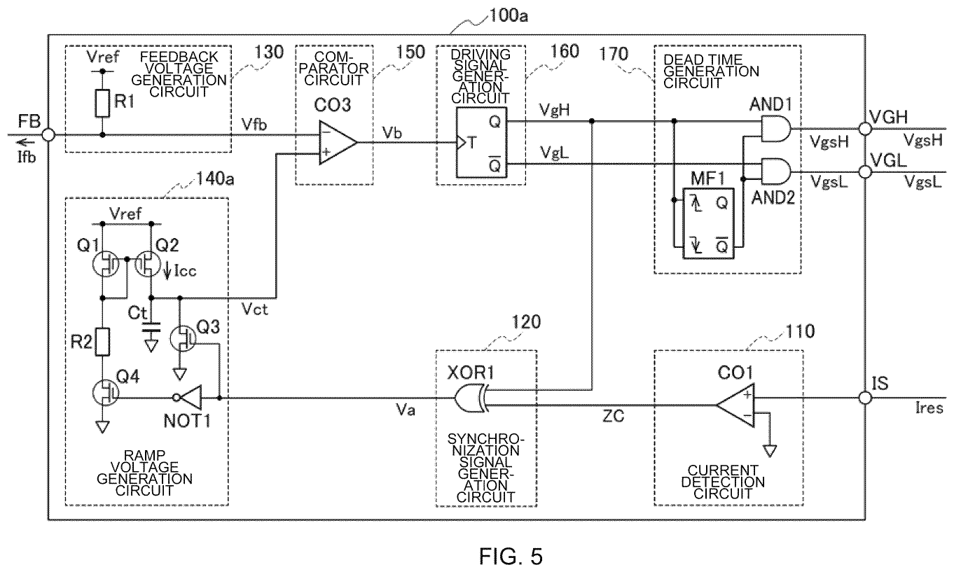

FIGS. 4 and 5 are diagrams illustrating a configuration of the LLC converter control circuit 100a according to a first example embodiment of the disclosure. The LLC converter control circuit 100a according to the first example embodiment illustrated in FIGS. 4 and 5 may be similar in configuration to the LLC converter control circuit 100A according to the comparative example illustrated in FIGS. 2A and 2B, except for including a ramp voltage generation circuit 140a instead of the ramp voltage generation circuit 140 and further including a feedback voltage generation circuit 130.

In the LLC converter control circuit 100A according to the comparative example illustrated in FIGS. 2A and 2B, the comparator circuit 150 may be configured to compare the ramp voltage Vct proportional to the feedback current Ifb with the reference voltage Vp determined in advance.

In the LLC converter control circuit 100a according to the first example embodiment, the comparator circuit 150 may be configured to perform a comparison between the ramp voltage Vct having a slope determined in advance and a feedback voltage Vfb. Such a configuration allows a sawtooth waveform of the ramp voltage Vct to decrease in amplitude with decreasing resonant current Ires, which helps to allow a current in the ramp voltage generation circuit 140a to decrease with decreasing resonant current Ires. The LLC converter control circuit 100a according to the first example embodiment thus helps to achieve lowered power consumption thereof during a light load condition, and consequently helps to allow the LLC converter 10 to achieve improved efficiency during a light load condition.

The feedback voltage generation circuit 130 may include a resistor R1. The feedback voltage generation circuit 130 may convert the feedback current Ifb of the LLC converter 10 into the feedback voltage Vfb, based on a reference voltage Vref and a resistance of the resistor R1. For example, the feedback voltage generation circuit 130 may generate the feedback voltage Vfb in accordance with Equation (1) below.

Vfb=Vref−Ifb×R1 . . . (1)

The ramp voltage generation circuit 140a may include transistors Q1 to Q4, the capacitor Ct, a resistor R2, and a circuit NOT1. The ramp voltage generation circuit 140a generates a sawtooth ramp voltage having a slope determined in advance, based on the first signal Va. The ramp voltage Vct may correspond to a specific but non-limiting example o f the “sawtooth ramp voltage” according to one embodiment of the disclosure. The ramp voltage generation circuit 140a may be configured to charge the capacitor Ct with a current Icc that is determined in advance based on a resistance of the resistor R2 and the reference voltage Vref.

When the first signal Va turns Low, the transistor Q3 may turn off and the transistor Q4 may turn on. When the transistor Q4 turns on, the current Icc determined in advance may flow through the transistor Q2, and the capacitor Ct may start being charged. The current Icc may be determined in accordance with Equation (2) below:

Icc=(Vref−Vth)/R2 . . . (2)
where “Vth” represents a threshold voltage of the transistor Q1.

When the first signal Va turns High, the transistor Q4 may turn off and the current Icc may decrease to zero. Further, the transistor Q3 may turn on and the ramp voltage Vct may be discharged to zero.

Accordingly, at a time tz at which the resonant current Ires crosses zero, the ramp voltage generation circuit 140a may start outputting the ramp voltage Vct that is a sawtooth voltage having a constant slope. The comparator circuit 150 generates the second signal Vb by performing a comparison between the feedback voltage Vfb and the ramp voltage Vct.

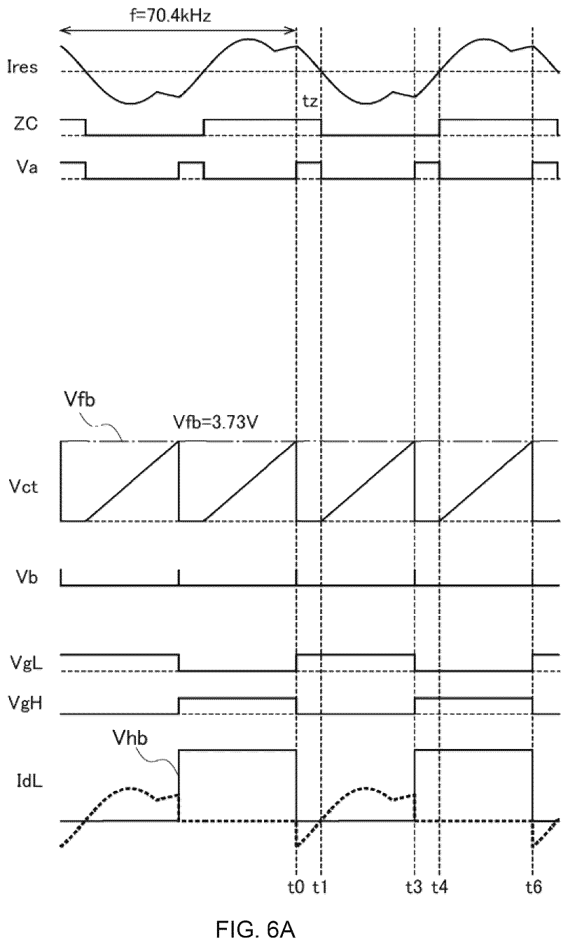

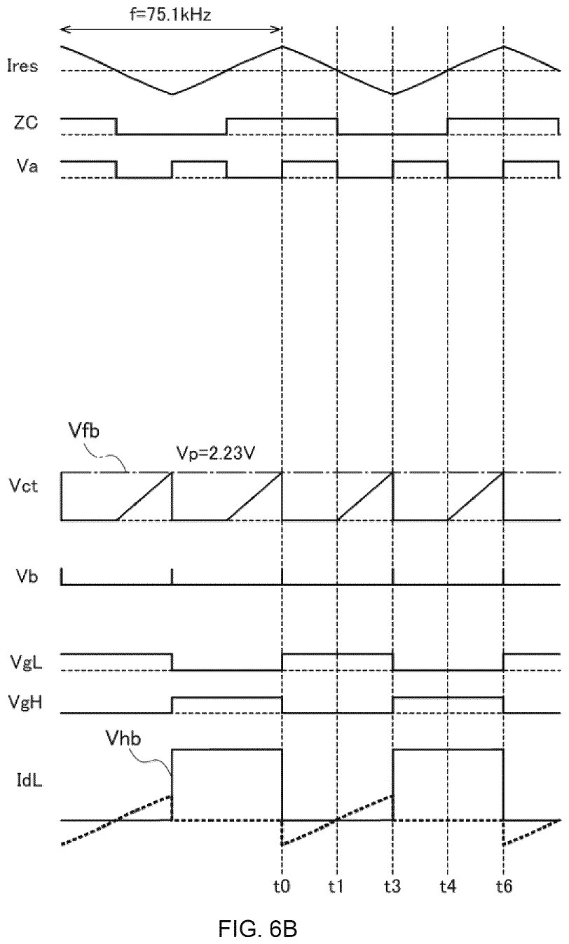

FIGS. 6A and 6B are diagrams for describing operations of the LLC converter control circuit 100a according to the first example embodiment with an output current of 10 A and an output current of 0.1 A, respectively.

At the time t0, the resonant current Ires may be positive and the zero-crossing signal ZC may be High. Further, at the time t0, the ramp voltage Vct of the capacitor Ct may become higher than the feedback voltage Vfb and the second signal Vb may thus turn High, which may cause the first driving signal VgH to turn Low, and cause the second driving signal VgL to turn High.

Due to the first driving signal VgH turning Low, the first signal Va to be outputted from the synchronization signal generation circuit 120 may turn High. When the first signal Va turns High, the ramp voltage Vct may be discharged to zero, which may cause the second signal Vb to turn Low.

At the time t1, the resonant current Ires may turn negative, and accordingly, the zero-crossing signal ZC may turn Low from High. When the zero-crossing signal ZC turns Low, the first signal Va to be outputted from the synchronization signal generation circuit 120 may turn Low, due to the first driving signal VgH being Low. When the first signal Va turns Low, the capacitor Ct may start being charged with the current Icc determined in advance. The ramp voltage Vct may start rising at the time t1, that is, at the zero-crossing point at which the resonant current Ires turns negative from positive.

At the time t3, the resonant current Ires may be negative and the zero-crossing signal ZC may be Low. Further, at the time t3, the ramp voltage Vct of the capacitor Ct may become higher than the feedback voltage Vfb and the second signal Vb may thus turn High, which may cause the first driving signal VgH to turn High, and cause the second driving signal VgL to turn Low.

Due to the first driving signal VgH turning High, the first signal Va to be outputted from the synchronization signal generation circuit 120 may turn High. When the first signal Va turns High, the ramp voltage Vct may be discharged to zero, which may cause the second signal Vb to turn Low.

At the time t4, the resonant current Ires may turn positive, and accordingly, the zero-crossing signal ZC may turn High from Low. When the zero-crossing signal ZC turns High, the first signal Va to be outputted from the synchronization signal generation circuit 120 may turn Low, due to the first driving signal VgH being High. When the first signal Va turns Low, the capacitor Ct may start being charged with the current Icc determined in advance. The ramp voltage Vct may start rising at the time t4, that is, at the zero-crossing point at which the resonant current Ires turns positive from negative.

At the time t6, the resonant current Ires may be positive and the zero-crossing signal ZC may be High. Further, at the time t6, the ramp voltage Vct of the capacitor Ct may become higher than the feedback voltage Vfb and the second signal Vb may thus turn High, which may cause the first driving signal VgH to turn Low, and cause the second driving signal VgL to turn High. Due to the first driving signal VgH turning Low, the first signal Va to be outputted from the synchronization signal generation circuit 120 may turn High. When the first signal Va turns High, the ramp voltage Vct may be discharged to zero, which may cause the second signal Vb to turn Low.

In the LLC converter control circuit 100a according to the first example embodiment, charging of the capacitor Ct may be performed with the current Icc determined in advance and, during a light load condition, the feedback voltage Vfb may be lowered to thereby decrease the amplitude of the ramp voltage Vct. A decrease in amplitude of the ramp voltage Vct during a light load condition is thus achievable, which helps to achieve a decrease in circuit current for generating the sawtooth waveform. Thus, in the LLC converter 10 according to the first example embodiment, the LLC converter control circuit 100a achieves lowered power consumption, which helps to improve efficiency during a light load condition.

### Second Example Embodiment

One example embodiment has been described above. The foregoing example embodiment is merely exemplary and non-limiting. For example, in the foregoing example embodiment, an example case has been described where the ramp voltage Vct having the slope determined in advance is compared with the feedback voltage Vfb. A description will now be given of the LLC converter control circuit 100b according to a second example embodiment that delays a negative edge of the first signal Va by a predetermined time to thereby achieve a further decrease in amplitude of the sawtooth waveform of the ramp voltage Vct during a light load condition. The description will focus on a configuration different from that in the first example embodiment.

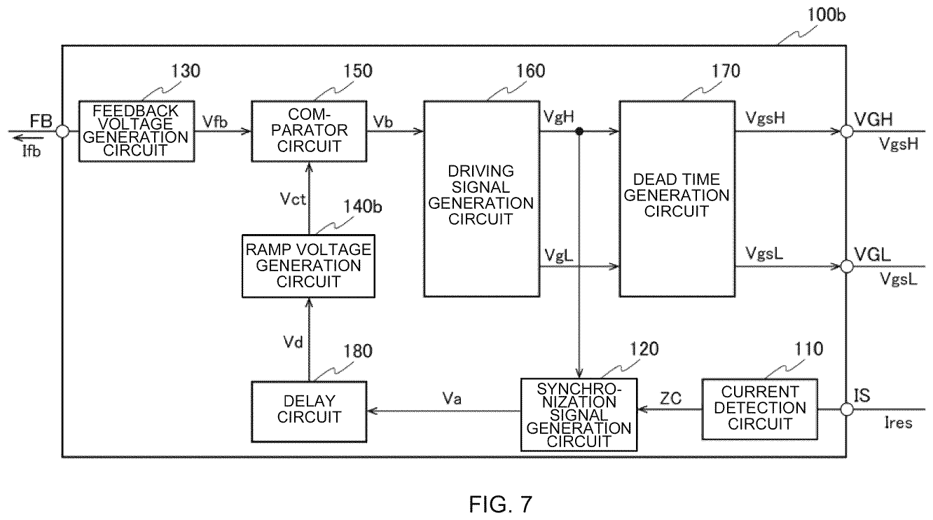

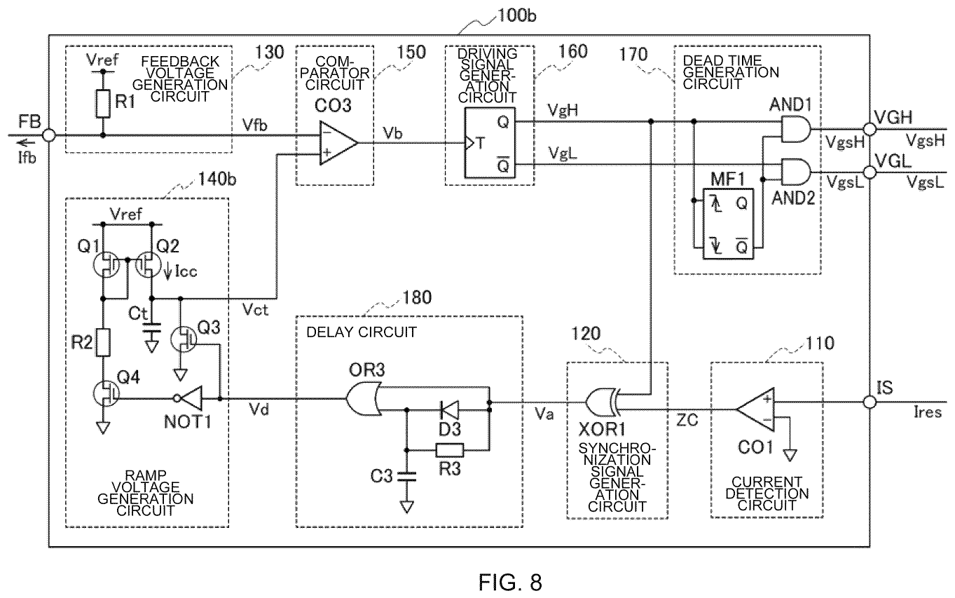

FIGS. 7 and 8 are diagrams illustrating the configuration of the LLC converter control circuit 100b according to the second example embodiment. As illustrated in FIGS. 7 and 8, the LLC converter control circuit 100b according to the second example embodiment may be different from the LLC converter control circuit 100a according to the first example embodiment in including a ramp voltage generation circuit 140b instead of the ramp voltage generation circuit 140a and further including a delay circuit 180. The ramp voltage generation circuit 140b may be similar to the ramp voltage generation circuit 140a in configuration. The delay circuit 180 may generate a delay signal Vd. The delay signal Vd may be the first signal Va whose negative edge is delayed by a time ts. With such a configuration, at a time delayed by the time ts from the time tz at which the resonant current Ires crosses zero, the ramp voltage generation circuit 140b may start outputting the ramp voltage Vct that is a sawtooth voltage having a slope determined in advance.

The delay circuit 180 may be configured to delay the negative edge of the first signal Va by the time ts. The delay circuit 180 may include a circuit OR3, a diode D3, a resistor R3, and a capacitor C3. The circuit OR3 may include two input terminals to receive two input signals. When the first signal Va turns High from Low, a voltage of the capacitor C3 may be turned High by the diode D3. As a result, the two input signals to be received at the circuit OR3 may both turn High, which may cause the delay signal Vd to turn High.

When the first signal Va turns Low from High, one of the two input signals to the circuit OR3 may turn Low, whereas another one of the two input signals may be delayed in turning Low by the time ts by a circuit including the capacitor C3 and the resistor R3. The delay circuit 180 may thus output the delay signal Vd, which is the first signal Va whose negative edge is delayed by the time ts.

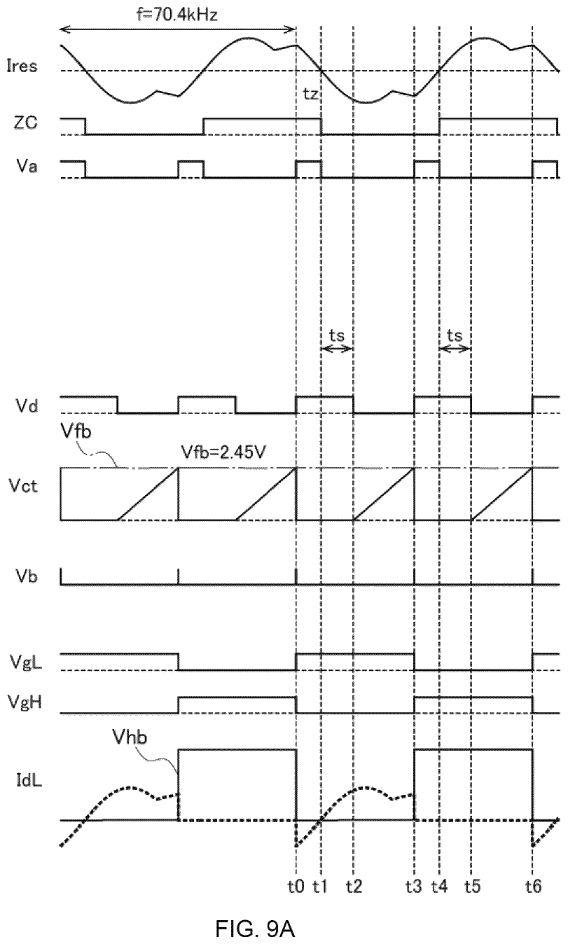

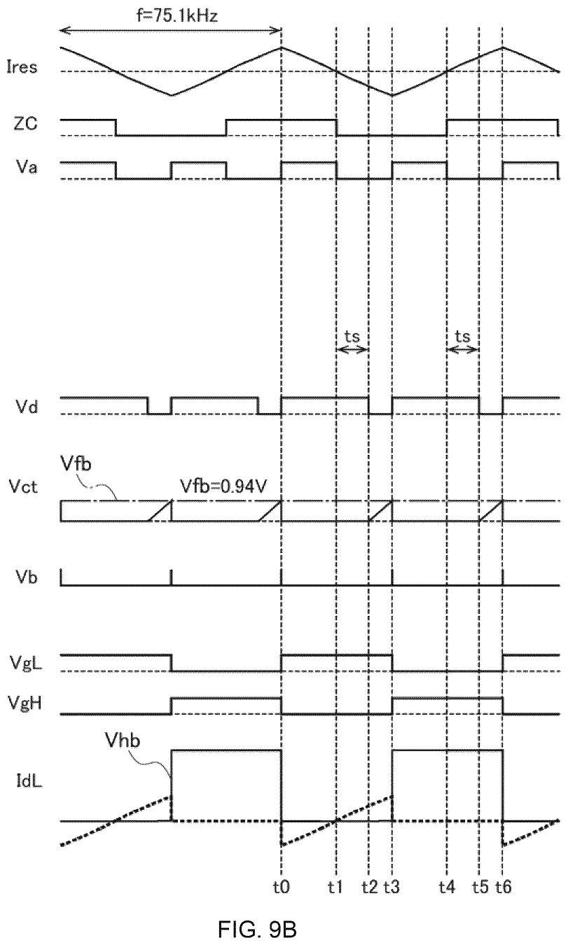

FIGS. 9A and 9B are diagrams for describing operations of the LLC converter control circuit 100b according to the second example embodiment with an output current of 10 A and an output current of 0.1 A, respectively.

At the time t0, the resonant current Ires may be positive and the zero-crossing signal ZC may be High. Further, at the time t0, the ramp voltage Vct of the capacitor Ct may become higher than the feedback voltage Vfb and the second signal Vb may thus turn High, which may cause the first driving signal VgH to turn Low, and cause the second driving signal VgL to turn High.

Due to the first driving signal VgH turning Low, the first signal Va to be outputted from the synchronization signal generation circuit 120 may turn High. When the first signal Va turns High, the delay signal Vd may turn High and the ramp voltage Vct may be discharged to zero, which may cause the second signal Vb to turn Low.

At the time t1, the resonant current Ires may turn negative, and accordingly, the zero-crossing signal ZC may turn Low from High. When the zero-crossing signal ZC turns Low, the first signal Va to be outputted from the synchronization signal generation circuit 120 may turn Low, due to the first driving signal VgH being Low.

At a time t2, that is, after a lapse of the time ts from the time t1 at which the first signal Va turns Low, the delay signal Vd may turn Low. When the delay signal Vd turns Low, the capacitor Ct may start being charged with the current Icc determined in advance. The ramp voltage Vct may start rising at the time t2, that is, after the lapse of the time ts from the zero-crossing point at which the resonant current Ires turns negative from positive.

At the time t3, the resonant current Ires may be negative and the zero-crossing signal ZC may be Low. Further, at the time t3, the ramp voltage Vct of the capacitor Ct may become higher than the feedback voltage Vfb and the second signal Vb may thus turn High, which may cause the first driving signal VgH to turn High, and cause the second driving signal VgL to turn Low. Due to the first driving signal VgH turning High, the first signal Va to be outputted from the synchronization signal generation circuit 120 may turn High. When the first signal Va turns High, the delay signal Vd may turn High and the ramp voltage Vct may be discharged to zero, which may cause the second signal Vb to turn Low.

At the time t4, the resonant current Ires may turn positive, and accordingly, the zero-crossing signal ZC may turn High from Low. When the zero-crossing signal ZC turns High, the first signal Va to be outputted from the synchronization signal generation circuit 120 may turn Low, due to the first driving signal VgH being High.

At a time t5, that is, after a lapse of the time ts from the time t4 at which the first signal Va turns Low, the delay signal Vd may turn Low. When the delay signal Vd turns Low, the capacitor Ct may start being charged with the current Icc determined in advance. The ramp voltage Vct may start rising at the time t5, that is, after the lapse of the time ts from the zero-crossing point at which the resonant current Ires turns positive from negative.

At the time t6, the resonant current Ires may be positive and the zero-crossing signal ZC may be High. Further, at the time t6, the ramp voltage Vct of the capacitor Ct may become higher than the feedback voltage Vfb and the second signal Vb may thus turn High, which may cause the first driving signal VgH to turn Low, and cause the second driving signal VgL to turn High.

Due to the first driving signal VgH turning Low, the first signal Va to be outputted from the synchronization signal generation circuit 120 may turn High. When the first signal Va turns High, the delay signal Vd may turn High and the ramp voltage Vct may be discharged to zero, which may cause the second signal Vb to turn Low.

The LLC converter control circuit 100b according to the second example embodiment also helps to decrease the amplitude of the ramp voltage Vct during a light load condition and to thereby achieve a decrease in circuit current for generating the sawtooth waveform. Thus, in the LLC converter 10 according to the second example embodiment, the LLC converter control circuit 100b achieves lowered power consumption, which helps to improve efficiency during a light load condition.

### Third Example Embodiment

Next, a third example embodiment will be described. Note that in the following description, the same reference signs as those in the first example embodiment and/or the second example embodiment denote the same or substantially the same configurations as those in the first example embodiment and/or the second example embodiment, and reference will be made to preceding descriptions regarding the relevant components or configurations unless otherwise specified. In the second example embodiment, an example configuration has been described that decreases the amplitude of the sawtooth waveform of the ramp voltage Vct during a light load condition by employing the delay time ts determined in advance. A duration of time that the first signal Va is High, which may hereinafter be referred to as “High duration of the first signal Va”, may increase as the load current (the resonant current Ires) decreases. A description will be given here of a configuration that provides a delay time equal to k times the High duration of the first signal Va. The description will focus on a configuration different from that in the second example embodiment.

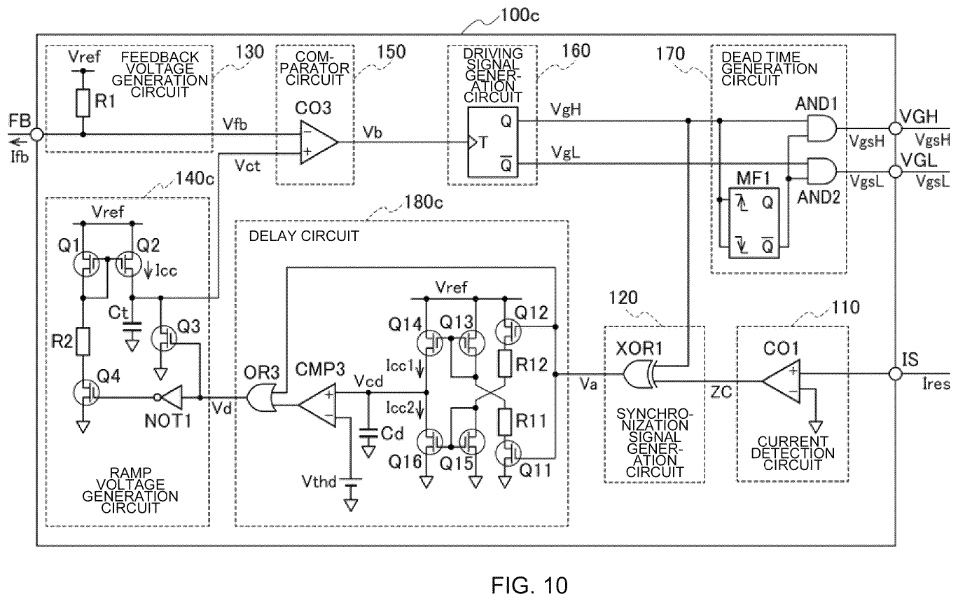

FIG. 10 is a diagram illustrating a detailed configuration of the LLC converter control circuit 100c according to the third example embodiment. As illustrated in FIG. 10, the LLC converter control circuit 100c according to the third example embodiment may be different from the LLC converter control circuit 100b illustrated in FIG. 8 in including a ramp voltage generation circuit 140c instead of the ramp voltage generation circuit 140b and including a delay circuit 180c instead of the delay circuit 180. The ramp voltage generation circuit 140c may be similar to the ramp voltage generation circuit 140b in configuration. The delay circuit 180c may be different from the delay circuit 180 in configuration.

The delay circuit 180c of the third example embodiment may include the circuit OR3, a comparator CMP3, a capacitor Cd, transistors Q11 to Q16, and resistors R11 and R12. When the first signal Va turns High, one of the two input signals to the circuit OR3 may turn High, and accordingly, the delay signal Vd may turn High. Further, when the first signal Va turns High, the transistor Q11 may turn on and the transistor Q12 may turn off. Due to the transistor Q11 turning on, the transistor Q13 may turn on to allow a current Icc1 to flow.

In this state, due to the transistor Q12 being off, the transistor Q15 may be off and a current Icc2 may be zero. The capacitor Cd may start being charged with the current Icc1. When a voltage Vcd of the capacitor Cd becomes higher than a threshold voltage Vthd, the comparator CMP3 may output “High”, and the other of the two input signals to the circuit OR3 may turn High.

When the first signal Va turns Low, one of the two input signals to the circuit OR3 may turn Low; however, the delay signal Vd may remain High due to the comparator CMP3 outputting “High”.

Further, when the first signal Va turns Low, the transistor Q11 may turn off and the transistor Q12 may turn on. Due to the transistor Q12 turning on, the transistor Q15 may turn on to allow the current Icc2 to flow. In this state, due to the transistor Q11 being off, the transistor Q13 may be off and the current Icc1 may be zero. The capacitor Cd may start being discharged with the current Icc2. When the voltage Vcd becomes lower than the threshold voltage Vthd, the comparator CMP3 may output “Low”, and the other of the two input signals to the circuit OR3 may turn Low. Accordingly, the delay signal Vd may turn Low.

If the threshold voltage Vthd is set to be as close to zero as possible to allow the currents Icc1 and Icc2 to be equal to each other, the delay signal Vd may turn Low after a lapse of the delay time ts equal to the High duration of the first signal Va. Further, if the current Icc2 is set to 2×Icc1, the delay signal Vd may turn Low after a delay of a half of the High duration of the first signal Va. Thus, the delay time ts proportional to the High duration of the first signal Va is achievable by adjusting a ratio between the currents Icc1 and Icc2, i.e., a ratio between resistances of the resistors R11 and R12.

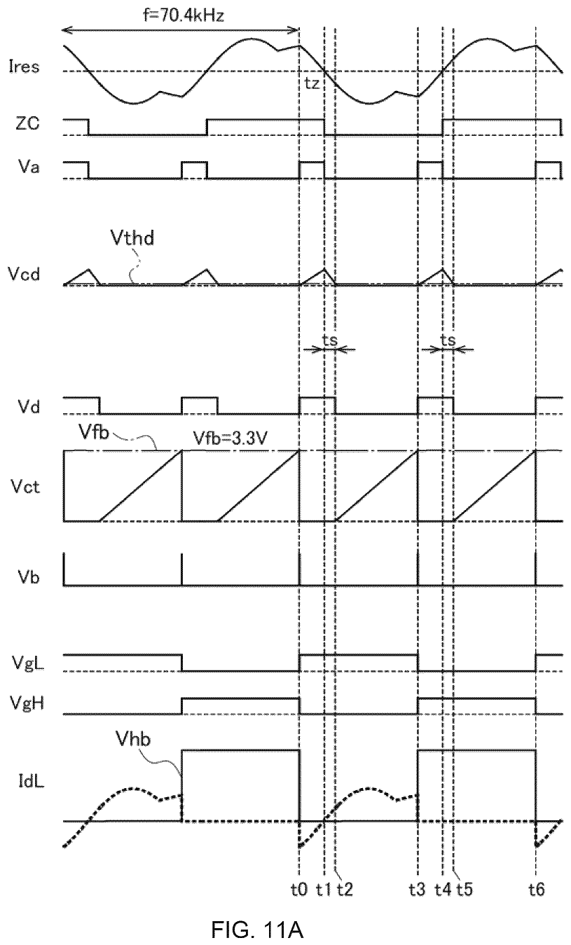

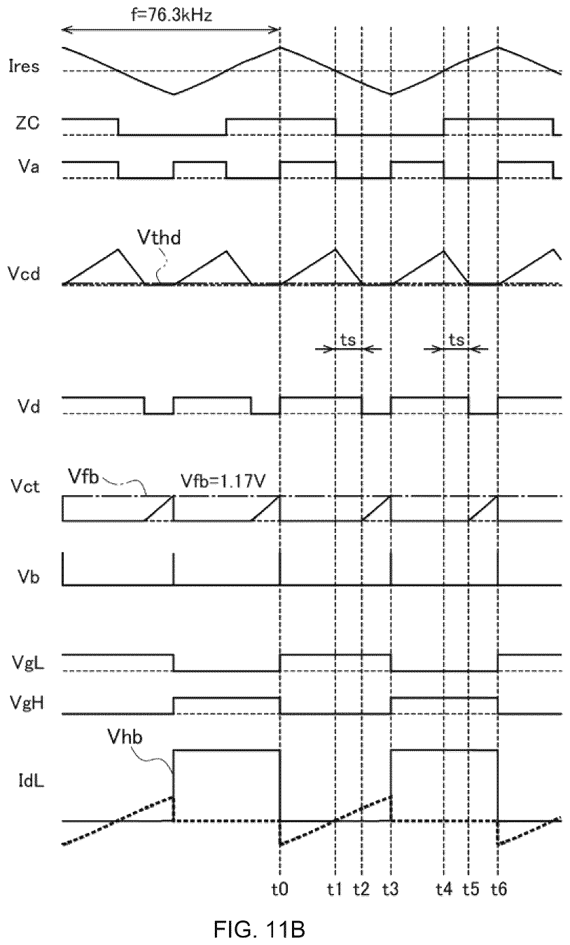

FIGS. 11A and 11B are diagrams for describing operations of the LLC converter control circuit 100c according to the third example embodiment with an output current of 10 A and an output current of 0.1 A, respectively.

At the time t0, the resonant current Ires may be positive and the zero-crossing signal ZC may be High. Further, at the time t0, the ramp voltage Vct of the capacitor Ct may become higher than the feedback voltage Vfb and the second signal Vb may thus turn High, which may cause the first driving signal VgH to turn Low, and cause the second driving signal VgL to turn High.

Due to the first driving signal VgH turning Low, the first signal Va to be outputted from the synchronization signal generation circuit 120 may turn High. When the first signal Va turns High, the delay signal Vd may be turned High by the circuit OR3 of the delay circuit 180c, and accordingly, the ramp voltage Vct may be discharged to zero, which may cause the second signal Vb to turn Low.

In the delay circuit 180c, when the first signal Va turns High, one of the two input signals to the circuit OR3 may turn High, and accordingly, the delay signal Vd may turn High. Further, when the first signal Va turns High, the transistor Q11 may turn on and the transistor Q12 may turn off. Due to the transistor Q11 turning on, the transistor Q13 may turn on to allow the current Icc1 to flow.

In this state, due to the transistor Q12 being off, the transistor Q15 may be off and the current Icc2 may be zero. The capacitor Cd may start being charged with the current Icc1. When the voltage Vcd becomes higher than the threshold voltage Vthd, the comparator CMP3 may output “High”, and the other of the two input signals to the circuit OR3 may turn High.

At the time t1, the resonant current Ires may turn negative, and accordingly, the zero-crossing signal ZC may turn Low from High. When the zero-crossing signal ZC turns Low, the first signal Va to be outputted from the synchronization signal generation circuit 120 may turn Low, due to the first driving signal VgH being Low.

When the first signal Va turns Low, one of the two input signals to the circuit OR3 may turn Low; however, the delay signal Vd may remain High due to the comparator CMP3 outputting “High”. Further, when the first signal Va turns Low, the transistor Q11 may turn off and the transistor Q12 may turn on. Due to the transistor Q12 turning on, the transistor Q15 may turn on to allow the current Icc2 to flow. In this state, due to the transistor Q11 being off, the transistor Q13 may be off and the current Icc1 may be zero. The capacitor Cd may start being discharged with the current Icc2.

At the time t2, the voltage Vcd may become lower than the threshold voltage Vthd, which may cause the comparator CMP3 to output “Low”, and cause the other of the two input signals to the circuit OR3 to turn Low. Accordingly, the delay signal Vd may turn Low. When the delay signal Vd turns Low, the capacitor Ct may start being charged with the current Icc determined in advance. The ramp voltage Vct may start rising at the time t2, that is, after the lapse of the time ts from the zero-crossing point at which the resonant current Ires turns negative from positive. Operations at and after the time t3 may be similar to the above-described operations, and the description thereof will thus be omitted here.

The LLC converter control circuit 100c according to the third example embodiment also helps to decrease the amplitude of the ramp voltage Vct during a light load condition and to thereby achieve a decrease in circuit current for generating the sawtooth waveform. Thus, in the LLC converter 10 according to the third example embodiment, the LLC converter control circuit 100c achieves lowered power consumption, which helps to improve efficiency during a light load condition.

### Fourth Example Embodiment

Next, a fourth example embodiment will be described. Note that in the following description, the same reference signs as those in any of the first to third example embodiments denote the same or substantially the same configurations as those in relevant one(s) of the first to third example embodiments, and reference will be made to preceding descriptions regarding the relevant components or configurations unless otherwise specified. In the third example embodiment, an example configuration has been described that provides the delay time equal to k times the duration of time that the first signal Va is High. Such a configuration, however, can sometimes result in an imbalance between respective on-widths of the high side switch QH and the low side switch QL. The imbalance between the respective on-widths of the high side switch QH and the low side switch QL can increase an effective current value of a current flowing through a switching circuit, and can thus decrease efficiency. Here, a description will be given of a configuration of the LLC converter control circuit 100d according to the fourth example embodiment that helps to bring respective on-durations of the high side switch QH and the low side switch QL into balance even during a light load condition.

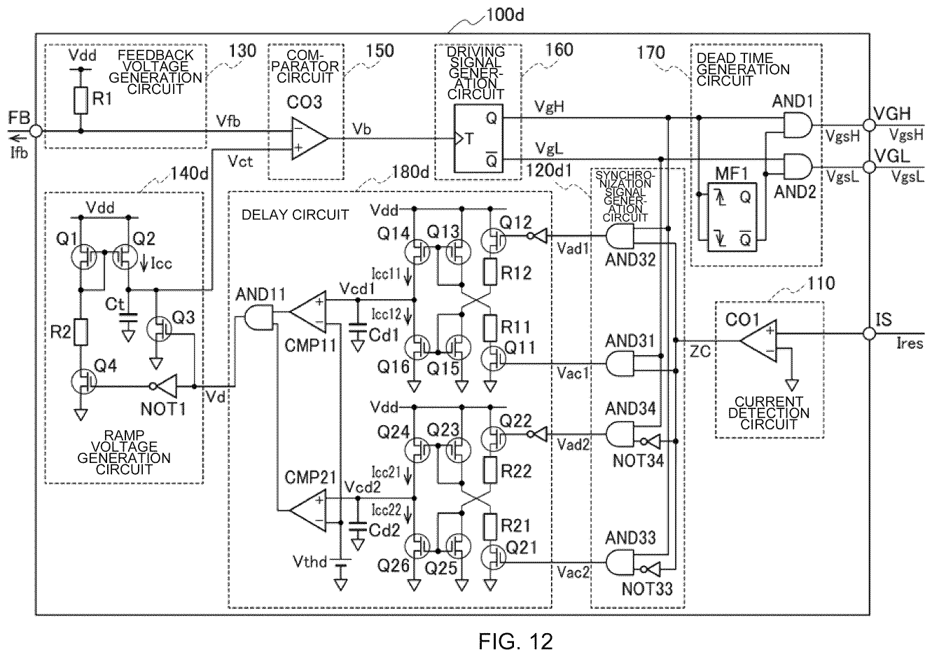

FIG. 12 is a diagram illustrating the configuration of the LLC converter control circuit 100d according to the fourth example embodiment. The LLC converter control circuit 100d according to the fourth example embodiment may include a synchronization signal generation circuit 120d1, a delay circuit 180d, and a ramp voltage generation circuit 140d.

The synchronization signal generation circuit 120d1 may include circuits AND31 to AND34 and circuits NOT33 and NOT34. The synchronization signal generation circuit 120d1 may send out a first signal Vac1 that is to be High during a period when a current flowing through the low side switch QL is negative. Further, the synchronization signal generation circuit 120d1 may send out a first signal Vac2 that is to be High during a period when a current flowing through the high side switch QH is negative. Further, the synchronization signal generation circuit 120d1 may send out a first signal Vad2 that is to be High during a period when the current flowing through the low side switch QL is positive. Further, the synchronization signal generation circuit 120d1 may send out a first signal Vad1 that is to be High during a period when the current flowing through the high side switch QH is positive.

In an example illustrated in FIG. 12, when the current flowing through the low side switch QL is negative, the zero-crossing signal may be High. Accordingly, the first signal Vac1 of the synchronization signal generation circuit 120d1 may be obtained through a logical AND operation on the second driving signal VgL and the zero-crossing signal ZC performed by the circuit AND31.

When the current flowing through the high side switch QH is negative, the zero-crossing signal ZC may be Low. Accordingly, the first signal Vac2 may be obtained through a logical AND operation on the first driving signal VgH and an inverted version of the zero-crossing signal ZC performed by the circuit AND33. The inverted version of the zero-crossing signal ZC may be outputted from the circuit NOT33.

When the current flowing through the low side switch QL is positive, the zero-crossing signal ZC may be Low. Accordingly, the first signal Vad2 may be obtained through a logical AND operation on the second driving signal VgL and the inverted version of the zero-crossing signal ZC performed by the circuit AND34. The inverted version of the zero-crossing signal ZC may be outputted from the circuit NOT34.

When the current flowing through the high side switch QH is positive, the zero-crossing signal ZC may be High. Accordingly, the first signal Vad1 may be obtained through a logical AND operation on the first driving signal VgH and the zero-crossing signal ZC performed by the circuit AND32.

The delay circuit 180d may include a circuit AND11, comparators CMP11 and CMP21, capacitors Cd1 and Cd2, the transistors Q11 to Q16, transistors Q21 to Q26, the resistors R11 and R12, and resistors R21 and R22. When the first signal Vac1 turns High, the transistor Q11 may turn on. From a voltage line to which a voltage Vdd is applied, a current determined by the voltage Vdd and the resistance of the resistor R11 may flow through the transistor Q13 to the resistor R11, and from the resistor R11 to the transistor Q11. This may allow a current Icc11 to flow through a current mirror circuit including the transistors Q13 and Q14. Accordingly, when the first signal Vac1 turns High, the delay circuit 180d may charge the capacitor Cd1 with the current Icc11.

When the first signal Vad1 turns High, the transistor Q12 may turn on. From the voltage line to which the voltage Vdd is applied, a current determined by the voltage Vdd and the resistance of the resistor R12 may flow through the resistor R12 to the transistor Q15. This may allow a current Icc12 to flow through a current mirror circuit including the transistors Q15 and Q16. Accordingly, when the first signal Vad1 turns High, the delay circuit 180d may discharge the capacitor Cd1 with the current Icc12.

When the first signal Vac2 turns High, the transistor Q21 may turn on. From the voltage line to which the voltage Vdd is applied, a current determined by the voltage Vdd and a resistance of the resistor R21 may flow through the transistor Q23 to the resistor R21, and from the resistor R21 to the transistor Q21. This may cause a current Icc21 to flow through a current mirror circuit including the transistors Q23 and Q24. Accordingly, when the first signal Vac2 turns High, the delay circuit 180d may charge the capacitor Cd2 with the current Icc21.

When the first signal Vad2 turns High, the transistor Q22 may turn on. From the voltage line to which the voltage Vdd is applied, a current determined by the voltage Vdd and a resistance of the resistor R22 may flow through the resistor R22 to the transistor Q25. This may allow a current Icc22 to flow through a current mirror circuit including the transistors Q25 and Q26. Accordingly, when the first signal Vad2 turns High, the delay circuit 180d may discharge the capacitor Cd2 with the current Icc22.

The comparator CMP11 may output “High” when a voltage Vcd1 of the capacitor Cd1 is higher than the threshold voltage Vthd, and output “Low” when the voltage Vcd1 is lower than the threshold voltage Vthd. The comparator CMP21 may output “High” when a voltage Vcd2 of the capacitor Cd2 is higher than the threshold voltage Vthd, and output “Low” when the voltage Vcd2 is lower than the threshold voltage Vthd.

The circuit AND11 may be configured to send out the delay signal Vd by ANDing respective comparison results of the comparators CMP11 and CMP21 with each other.

If the currents Icc11 and Icc12 are set to a ratio of m:1 (where m<1), the delay circuit 180d may charge the capacitor Cd1 with the current Icc11 during a period of time TnL when the current flowing through the low side switch QL is negative, and may discharge the capacitor Cd1 with the current Icc12 after the current flowing through the high side switch QH turns positive. Accordingly, the period of time TnL when the current flowing through the low side switch QL is negative and a time tsH by which a rising time of the sawtooth ramp voltage (the ramp voltage Vct) for controlling the high side switch QH is to be delayed from a zero-crossing point may have the following relationship: tsH=m×TnL. This allows the rising time of the sawtooth ramp voltage to be delayed by the time tsH (=m×TnL) proportional to the period of time TnL when the current flowing through the low side switch QL is negative. A delay of the sawtooth ramp voltage (the ramp voltage Vct) through discharging of the capacitor Cd2 with the current Icc22 may also be achievable on a principle similar to the above.

Further, because of a relationship that Icc11=m×Icc12, a change in voltage of the capacitor Ct may be given as follows: Icc11×tn/Ct=Icc12×ts/Ct. Accordingly, the following relationships may hold: m×Icc12×tn=Icc12×ts; and ts=m×tn.

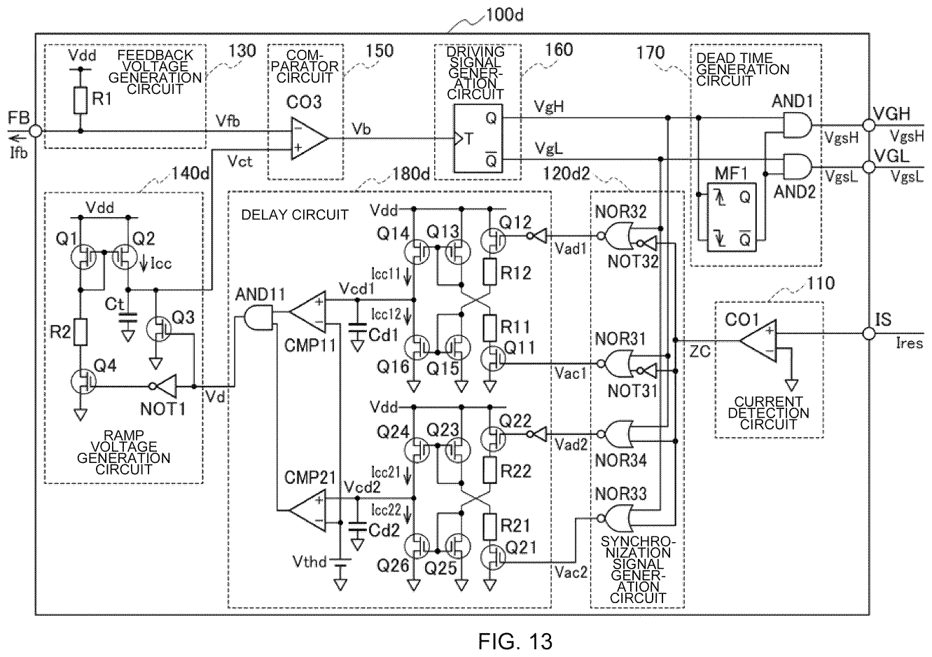

FIGS. 13 to 15 illustrate modification examples of the LLC converter control circuit 100d according to the fourth example embodiment. The modification examples may include respective synchronization signal generation circuits 120d2 to 120d4 each having a configuration different from that of the synchronization signal generation circuit 120d1.

### Modification Example 1

In Modification Example 1 illustrated in FIG. 13, the synchronization signal generation circuit 120d2 may include circuits NOR31 to NOR34, and circuits NOT31 and NOT32. When the current flowing through the low side switch QL is negative, the zero-crossing signal ZC may be High. Accordingly, the first signal Vac1 of the synchronization signal generation circuit 120d2 may be obtained through a logical NOR operation (i.e., inversion of a logical OR operation) on the first driving signal VgH and the inverted version of the zero-crossing signal ZC performed by the circuit NOR31. The inverted version of the zero-crossing signal ZC may be outputted from the circuit NOT31.

When the current flowing through the high side switch QH is negative, the zero-crossing signal ZC may be Low. Accordingly, the first signal Vac2 may be obtained through a logical NOR operation on the second driving signal VgL and the zero-crossing signal ZC performed by the circuit NOR33.

When the current flowing through the low side switch QL is positive, the zero-crossing signal ZC may be Low. Accordingly, the first signal Vad2 may be obtained through a logical NOR operation on the first driving signal VgH and the zero-crossing signal ZC performed by the circuit NOR34.

When the current flowing through the high side switch QH is positive, the zero-crossing signal ZC may be High. Accordingly, the first signal Vad1 may be obtained through a logical NOR operation on the second driving signal VgL and the inverted version of the zero-crossing signal ZC performed by the circuit NOR32. The inverted version of the zero-crossing signal ZC may be outputted from the circuit NOT32.

### Modification Example 2

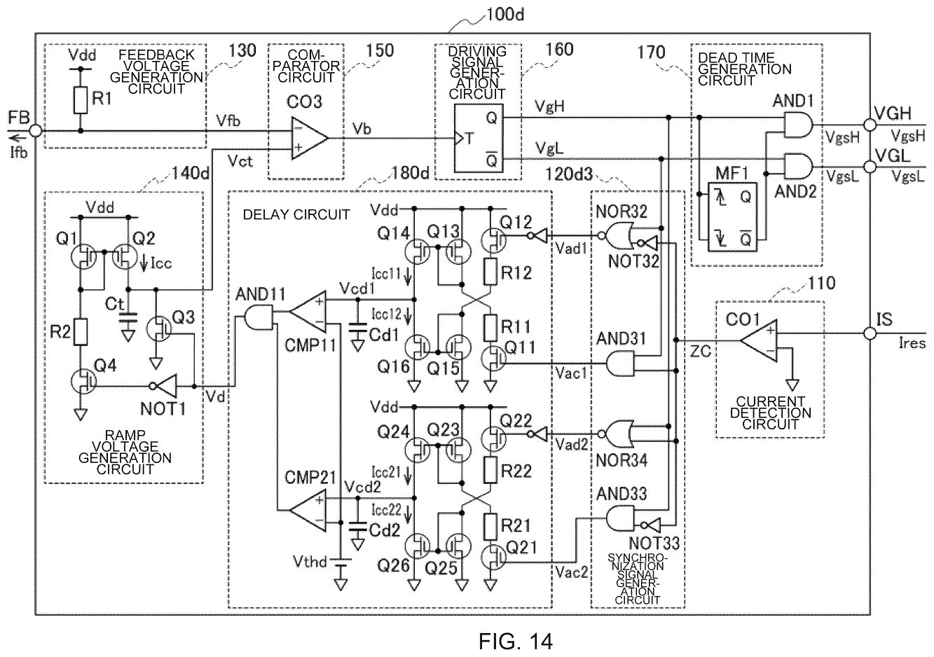

In Modification Example 2 illustrated in FIG. 14, the synchronization signal generation circuit 120d3 may include the circuits AND31 and AND33, the circuits NOR32 and NOR34, and the circuits NOT32 and NOT33. When the current flowing through the low side switch QL is negative, the zero-crossing signal ZC may be High. Accordingly, the first signal Vac1 of the synchronization signal generation circuit 120d3 may be obtained through the logical AND operation on the second driving signal VgL and the zero-crossing signal ZC performed by the circuit AND31.

When the current flowing through the high side switch QH is negative, the zero-crossing signal ZC may be Low. Accordingly, the first signal Vac2 may be obtained through the logical AND operation on the first driving signal VgH and the inverted version of the zero-crossing signal ZC performed by the circuit AND33. The inverted version of the zero-crossing signal ZC may be outputted from the circuit NOT33.

When the current flowing through the low side switch QL is positive, the zero-crossing signal ZC may be Low. Accordingly, the first signal Vad2 may be obtained through the logical NOR operation on the first driving signal VgH and the zero-crossing signal ZC performed by the circuit NOR34.

When the current flowing through the high side switch QH is positive, the zero-crossing signal ZC may be High. Accordingly, the first signal Vad1 may be obtained through the logical NOR operation on the second driving signal VgL and the inverted version of the zero-crossing signal ZC performed by the circuit NOR32. The inverted version of the zero-crossing signal ZC may be outputted from the circuit NOT32.

### Modification Example 3

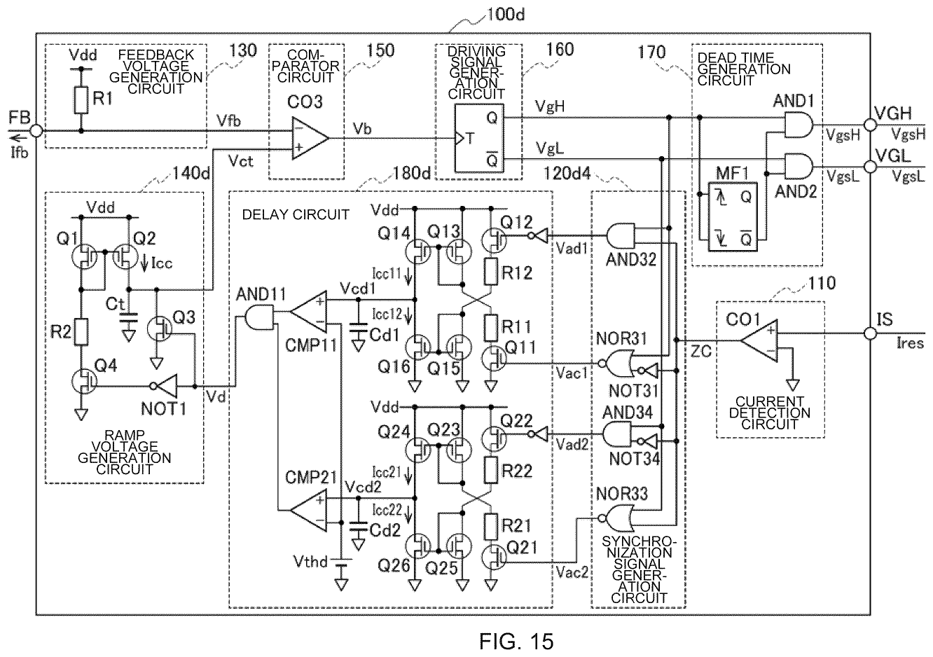

In Modification Example 3 illustrated in FIG. 15, the synchronization signal generation circuit 120d4 may include the circuits AND32 and AND34, the circuits NOR31 and NOR33, and the circuits NOT31 and NOT34. When the current flowing through the low side switch QL is negative, the zero-crossing signal ZC may be High. Accordingly, the first signal Vac1 of the synchronization signal generation circuit 120d4 may be obtained through the logical NOR operation on the first driving signal VgH and the inverted version of the zero-crossing signal ZC performed by the circuit NOR31. The inverted version of the zero-crossing signal ZC may be outputted from the circuit NOT31.

When the current flowing through the high side switch QH is negative, the zero-crossing signal ZC may be Low. Accordingly, the first signal Vac2 may be obtained through the logical NOR operation on the second driving signal VgL and the zero-crossing signal ZC performed by the circuit NOR33.

When the current flowing through the low side switch QL is positive, the zero-crossing signal ZC may be Low. Accordingly, the first signal Vad2 may be obtained through the logical AND operation on the second driving signal VgL and the inverted version of the zero-crossing signal ZC performed by the circuit AND34. The inverted version of the zero-crossing signal ZC may be outputted from the circuit NOT34.

When the current flowing through the high side switch QH is positive, the zero-crossing signal ZC may be High. Accordingly, the first signal Vad1 may be obtained through the logical AND operation on the first driving signal VgH and the zero-crossing signal ZC performed by the circuit AND32.

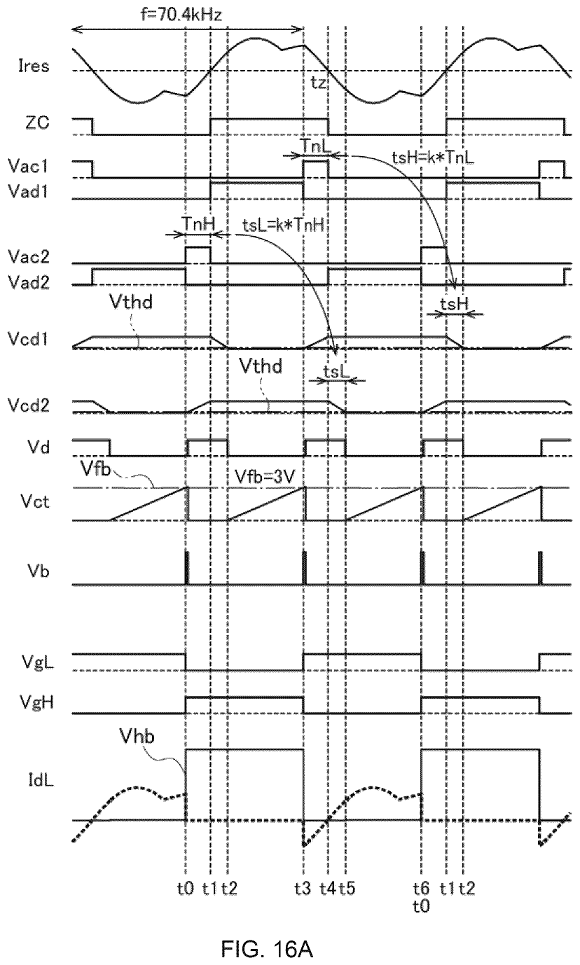

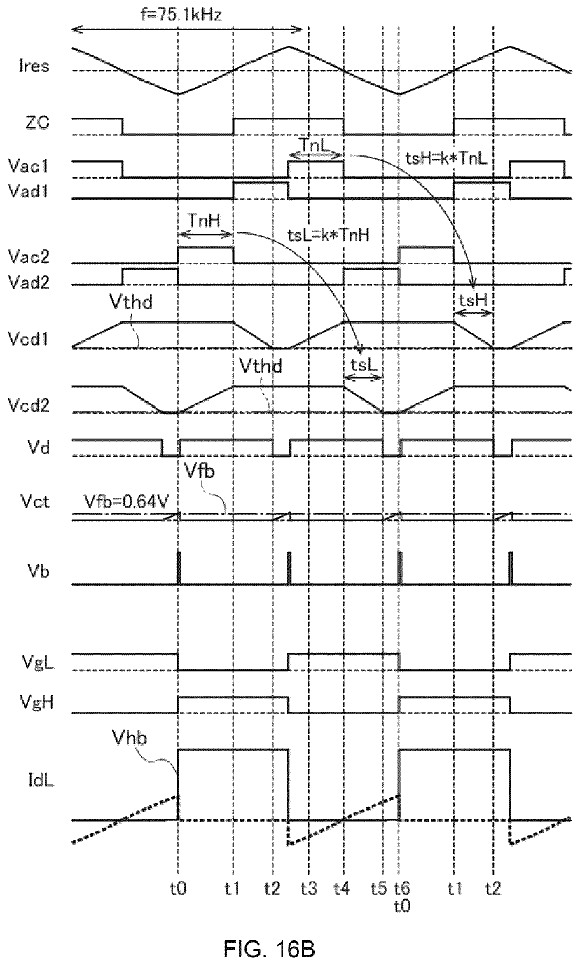

FIGS. 16A and 16B are diagrams for describing operations of the LLC converter control circuits 100d according to the fourth example embodiment with an output current of 10 A and an output current of 0.1 A, respectively. Note that unless otherwise specified, the LLC converter control circuits 100d according to Modification Examples 1 to 3 described above may each also be collectively referred to herein as the “LLC converter control circuit 100d according to the fourth example embodiment”.

As compared with the LLC converter control circuit 100c according to the third example embodiment, the LLC converter control circuits 100d according to the fourth example embodiment and Modification Examples 1 to 3 are different in the synchronization signal generation circuits 120d1 to 120d4 and the delay circuit 180d. Accordingly, a description will be given here of a process of generating the delay signal Vd based on the zero-crossing signal ZC.

At the time t0, the zero-crossing signal ZC may be Low. Due to the voltage Vcd1 of the capacitor Cd1 being higher than the threshold voltage Vthd, the comparator CMP11 may output “High”. Due to the voltage Vcd2 of the capacitor Cd2 being lower than the threshold voltage Vthd, the comparator CMP21 may output “Low”. The circuit AND11 may therefore output “Low”. Accordingly, the delay signal Vd may be “Low”.

At the time t0, the ramp voltage Vct of the capacitor Ct may become higher than the feedback voltage Vfb and the second signal Vb may thus turn High, which may cause the first driving signal VgH to turn High, and cause the second driving signal VgL to turn Low.

The first signal Vac2 may turn High from Low, and the first signal Vad2 may turn Low from High. When the first signal Vac2 turns High, the transistor Q21 may turn on, and the transistors Q23 and Q24 may turn on. The capacitor Cd2 may be charged with the current Icc21. When the voltage Vcd2 exceeds the threshold voltage Vthd, the comparator CMP21 may output “High”.

Due to the comparator CMP11 outputting “High”, the delay signal Vd may turn High. When the delay signal Vd turns High, in the ramp voltage generation circuit 140d, the transistor Q4 may turn off, the transistor Q3 may turn on, and the capacitor Ct may be discharged. As a result, the second signal Vb to be outputted from the comparator circuit 150 may turn Low.

At the time t1, the resonant current Ires may turn positive, and accordingly, the zero-crossing signal ZC may turn High from Low. The first signal Vac2 may turn Low from High, and the first signal Vad1 may turn High from Low. As a result, due to both the first signal Vac2 and the first signal Vad2 being Low, the capacitor Cd2 may keep its voltage.

In contrast, due to the first signal Vac1 and the first signal Vad1 being respectively Low and High, the capacitor Cd1 may be discharged with the current Icc12, and the voltage Vcd1 may thus decrease in value.

At the time t2, the voltage Vcd1 may become lower than the threshold voltage Vthd. Accordingly, the comparator CMP11 may output “Low”, the circuit AND11 may output “Low”, and the delay signal Vd may turn Low. When the delay signal Vd turns Low, in the ramp voltage generation circuit 140d, the transistor Q3 may turn off, the transistor Q4 may turn on, and the capacitor Ct may start being charged with the current Icc that flows based on the resistance of the resistor R2.

At the time t3, the ramp voltage Vct of the capacitor Ct may become higher than the feedback voltage Vfb and the second signal Vb may thus turn High, which may cause the first driving signal VgH to turn Low, and cause the second driving signal VgL to turn High. Further, the first signal Vac1 may turn High from Low, and the first signal Vad1 may turn Low from High.

When the first signal Vac1 turns High, the transistor Q11 may turn on, and the transistors Q13 and Q14 may turn on. The capacitor Cd1 may thus be charged with the current Icc11. When the voltage Vcd1 exceeds the threshold voltage Vthd, the comparator CMP11 may output “High”. The delay signal Vd may turn High, due to the comparator CMP21 outputting “High”. When the delay signal Vd turns High, in the ramp voltage generation circuit 140d, the transistor Q4 may turn off, the transistor Q3 may turn on, and the capacitor Ct may be discharged. As a result, the second signal Vb to be outputted from the comparator circuit 150 may turn Low.

At the time t4, the resonant current Ires may turn negative, and accordingly, the zero-crossing signal ZC may turn Low from High. The first signal Vac1 may turn Low from High, and the first signal Vad2 may turn High from Low. As a result, due to both the first signal Vac1 and the first signal Vad1 being Low, the capacitor Cd1 may keep its voltage. In contrast, due to the first signal Vac2 and the first signal Vad2 being respectively Low and High, the capacitor Cd2 may be discharged with the current Icc22, and the voltage Vcd2 may decrease in voltage value.

At the time t5, the voltage Vcd2 may become lower than the threshold voltage Vthd. Accordingly, the comparator CMP21 may output “Low”, the circuit AND11 may output “Low”, and the delay signal Vd may turn Low. When the delay signal Vd turns Low, in the ramp voltage generation circuit 140d, the transistor Q3 may turn off, the transistor Q4 may turn on, and the capacitor Ct may start being charged with the current Icc that flows based on the resistance of the resistor R2.

At the time t6, the ramp voltage Vct of the capacitor Ct may become higher than the feedback voltage Vfb and the second signal Vb may thus turn High, which may cause the second driving signal VgL to turn Low, and cause the first driving signal VgH to turn High. Further, the first signal Vac2 may turn High from Low, and the first signal Vad2 may turn Low from High.

When the first signal Vac2 turns High, the transistor Q21 may turn on, and the transistors Q23 and Q24 may turn on. The capacitor Cd2 may thus be charged with the current Icc21. When the voltage Vcd2 exceeds the threshold voltage Vthd, the comparator CMP21 may output “High”. The delay signal Vd may turn High, due to the comparator CMP11 outputting “High”. When the delay signal Vd turns High, in the ramp voltage generation circuit 140d, the transistor Q4 may turn off, the transistor Q3 may turn on, and the capacitor Ct may be discharged. As a result, the second signal Vb to be outputted from the comparator circuit 150 may turn Low.

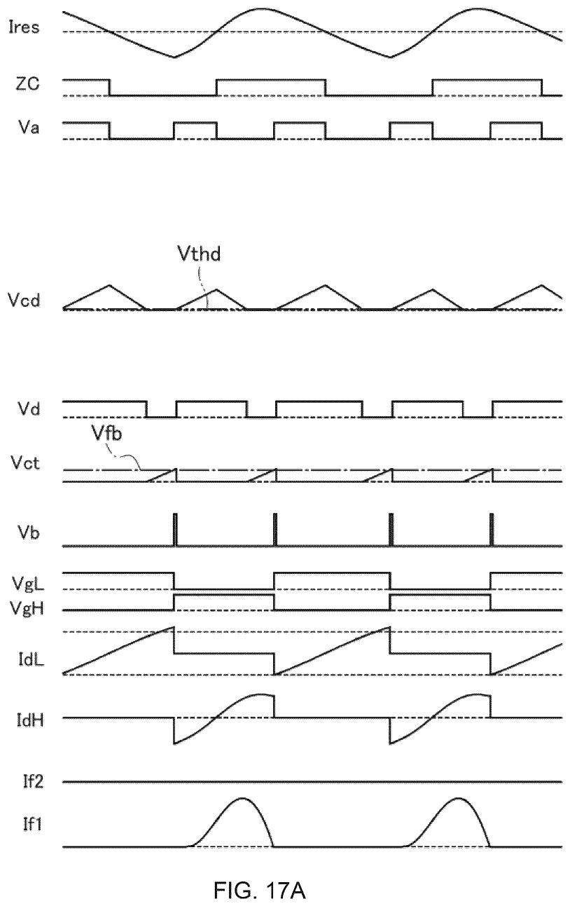

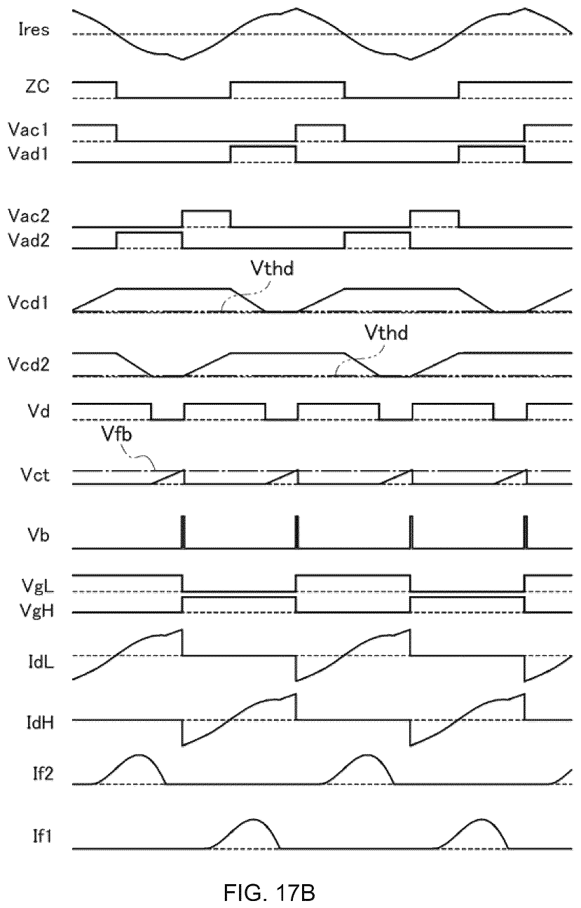

FIG. 17A is a diagram for describing an operation of the LLC converter control circuit 100c according to the third example embodiment during an imbalanced operating condition as a comparative example. FIG. 17B is a diagram for describing an operation of the LLC converter control circuit 100d according to the fourth example embodiment. Note that FIGS. 17A and 17B each illustrate an example with an output current of 2 A.

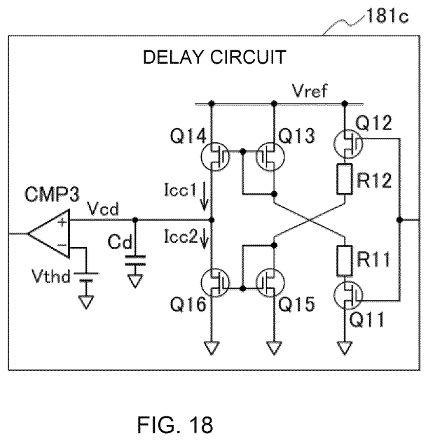

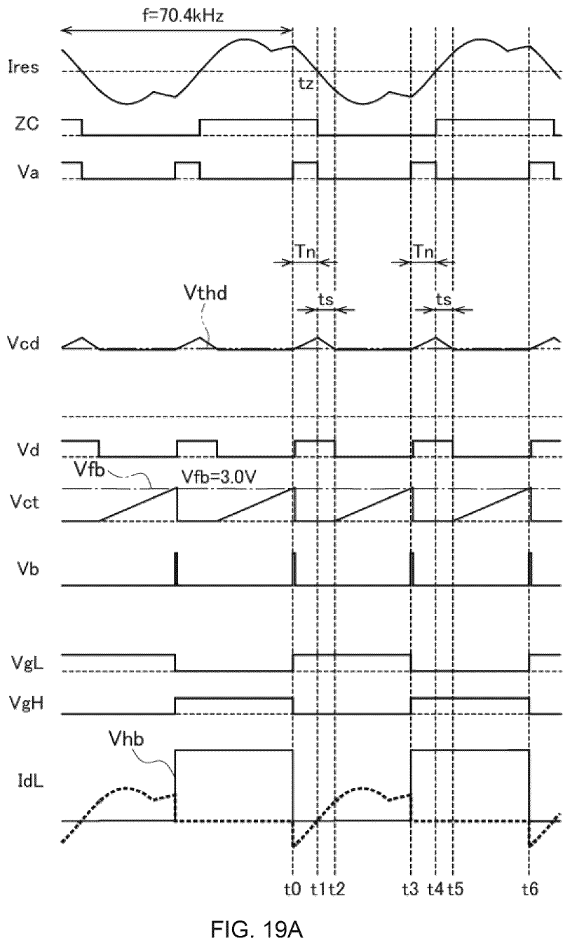

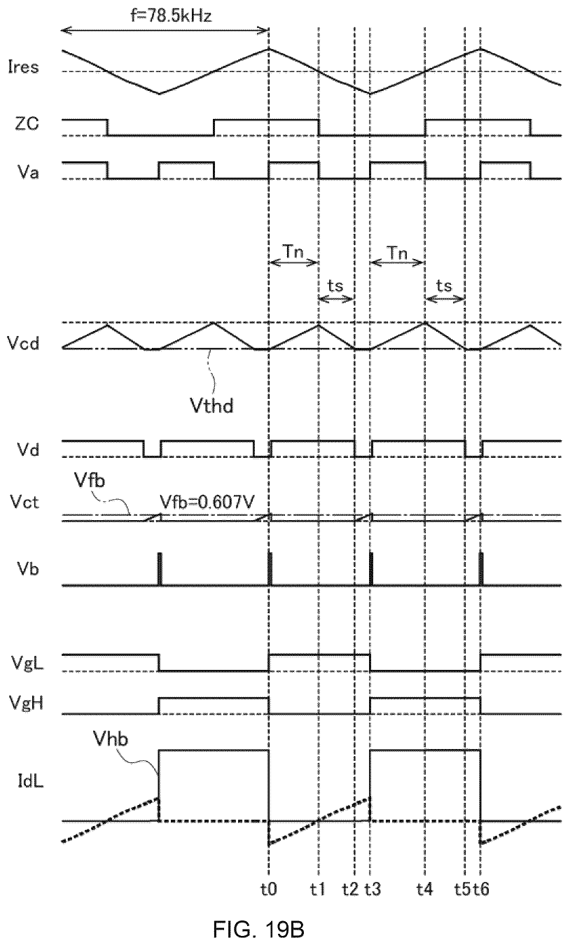

For the operation example illustrated in FIG. 17A, a delay circuit 181c illustrated in FIG. 18 is used that corresponds to the delay circuit 180c illustrated in FIG. 10 from which the circuit OR3 is omitted. FIGS. 19A and 19B illustrate waveforms, corresponding to those of FIGS. 11A and 11B, obtainable with the LLC converter control circuit 100c according to the third example embodiment where the delay circuit 181c illustrated in FIG. 18 is employed. Operations illustrated in FIGS. 19A and 19B are similar to those described with reference to FIGS. 11A and 11B, and redundant description thereof will thus be omitted.

The description will proceed with reference back to FIGS. 17A and 17B. In the operation example of the LLC converter control circuit 100c according to the third example embodiment illustrated in FIG. 17A, the first driving signal VgH may have an on-width of 6.04 μs and the second driving signal VgL may have an on-width of 6.98 μs. An imbalance may thus develop between the respective on-widths of the first driving signal VgH and the second driving signal VgL. This results in a rise in operating frequency. Accordingly, of the two rectifying diodes on the secondary side (i.e., the first diode Ds1 and the second diode Ds2), only a single rectifying diode may allow a current to flow through. Referring to FIG. 17A, only a current If1 may flow through the first diode Ds1, with no current If2 flowing through the second diode Ds2.

In contrast, the LLC converter control circuits 100d according to the fourth example embodiment and Modification Examples 1 to 3 each help to improve the imbalance between the on-widths during a light load condition, owing to the provision of the delay circuit 180d and corresponding one of the synchronization signal generation circuits 120d1 to 120d4 illustrated in FIGS. 12 to 15. For example, the respective synchronization signal generation circuits 120d1 to 120d4 of the LLC converter control circuits 100d according to the fourth example embodiment and Modification Examples 1 to 3 each generate the first signals Vac1, Vac2, Vad1, and Vad2, based on the first driving signal VgH, the second driving signal VgL, and the zero-crossing signal ZC, to allow the respective on-widths of the first driving signal VgH and the second driving signal VgL to be equal to each other. Note that, in an embodiment of the disclosure, the respective on-widths of the first driving signal VgH and the second driving signal VgL being equal to each other is intended to mean not only that their respective on-widths are exactly equal to each other but also that their respective on-widths are equal to each other enough to eliminate any imbalance therebetween.

In the example illustrated in FIG. 17B, the respective on-widths of the first driving signal VgH and the second driving signal VgL may both be 6.8732 μs. An improvement in the imbalance between the on-widths is thus achievable.

### Fifth Example Embodiment

Next, a fifth example embodiment will be described. Note that in the following description, the same reference signs as those in any of the first to fourth example embodiments denote the same or substantially the same configurations as those in relevant one(s) of the first to fourth example embodiments, and reference will be made to preceding descriptions regarding the relevant components or configurations unless otherwise specified. In the third example embodiment, an example configuration has been described that provides the delay time equal to k times the duration of time that the first signal Va is High. Such a configuration, however, can sometimes result in imbalance between the respective on-widths of the high side switch QH and the low side switch QL. The imbalance between the respective on-widths of the high side switch QH and the low side switch QL can increase the effective current value of the current flowing through the switching circuit, and can thus result in decreased efficiency. Here, a description will be given of a configuration of the LLC converter control circuit 100e according to the fifth example embodiment that helps to bring the respective on-durations of the high side switch QH and the low side switch QL into balance even during a light load condition and that is different from the configuration of the LLC converter control circuit 100d.

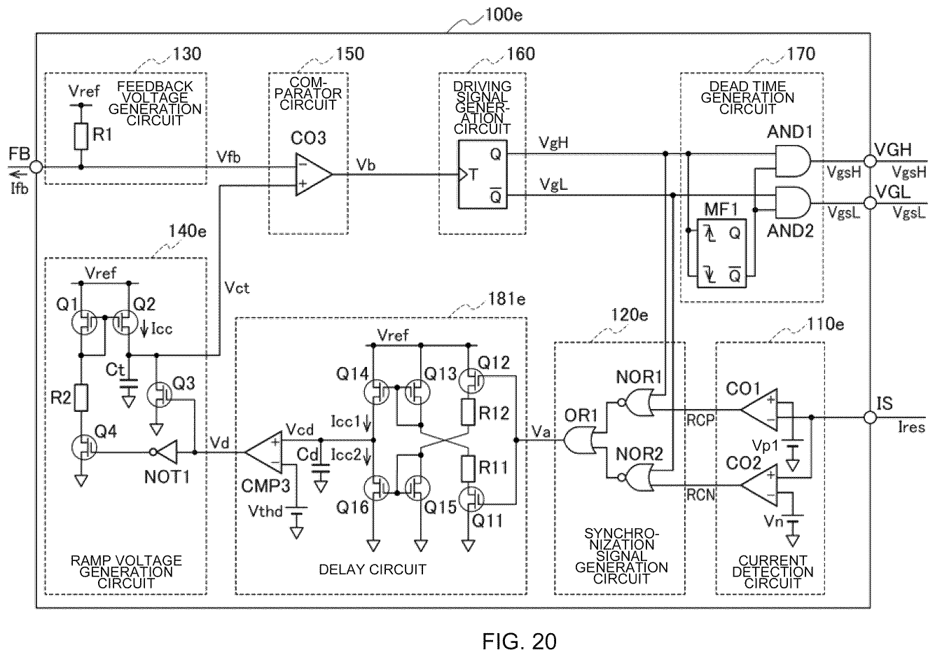

FIG. 20 is a diagram illustrating the configuration of the LLC converter control circuit 100e according to the fifth example embodiment. The LLC converter control circuit 100e may include a current detection circuit 110e, a synchronization signal generation circuit 120e, a delay circuit 181e, and a ramp voltage generation circuit 140e. The current detection circuit 110e, the synchronization signal generation circuit 120e, and the delay circuit 181e may be different in configuration from those of the foregoing first to fourth example embodiments. Note that the delay circuit 181e corresponds to the delay circuit 181c illustrated in FIG. 18, which corresponds to the delay circuit 180c of the third example embodiment from which the circuit OR3 is omitted.

The current detection circuit 110e may include a comparator CO1, and a circuit that generates a first reference voltage Vp1. The comparator CO1 may send out a first current detection result signal RCP. The first current detection result signal RCP may be High when a voltage value corresponding to the resonant current Ires (i.e., a value as a resultant of a conversion of the resonant current Ires into a voltage) is lower than the first reference voltage Vp1. The current detection circuit 110e may further include a comparator CO2, and a circuit that generates a second reference voltage Vn. The comparator CO2 may send out a second current detection result signal RCN. The second current detection result signal RCN may be High when the voltage value corresponding to the resonant current Ires is higher than the second reference voltage Vn. The first reference voltage Vp1 may be a positive voltage. The second reference voltage Vn may be a negative voltage. The first reference voltage Vp1 and the second reference voltage Vn may be equal to each other in absolute value.

The synchronization signal generation circuit 120e may include a circuit NOR1, a circuit NOR2, and a circuit OR1, and may have a configuration as illustrated in FIG. 20. The first signal Va may turn High when the circuit NOR1 or NOR2 outputs “High”. The circuit NOR1 may output “High” when the first driving signal VgH is Low and the first current detection result signal RCP is Low. Due to the first driving signal VgH and the second driving signal VgL being opposite to each other in terms of “High” and “Low” at all times, the circuit NOR1 may output “High” when the second driving signal VgL is High and the voltage value corresponding to the resonant current Ires is higher than the first reference voltage Vp1.

For example, the synchronization signal generation circuit 120e may output the first signal Va that is to be High when the first driving signal VgH is Low and the first current detection result signal RCP is Low. Further, the synchronization signal generation circuit 120e may output the first signal Va that is to be High when the second driving signal VgL is Low and the second current detection result signal RCN is Low.

In the LLC converter control circuit 100c according to the third example embodiment illustrated in FIG. 10, when the second driving signal VgL is High, the zero-crossing signal ZC may be High due to the first driving signal VgH being Low. In other words, when the second driving signal VgL is High, the resonant current Ires may be positive.

Accordingly, in the LLC converter control circuit 100c according to the third example embodiment, when the second driving signal VgL turns High from Low, the resonant current Ires may be positive and may thereafter decrease to zero. Thus, the duration of time that the first signal Va is High may be shorter in the LLC converter control circuit 100e than in the LLC converter control circuit 100c.

The circuit NOR2 may output “High” when the second driving signal VgL is Low and the second current detection result signal RCN is Low. Due to the first driving signal VgH and the second driving signal VgL being opposite to each other in terms of “High” and “Low” at all times, the circuit NOR2 may output “High” when the first driving signal VgH is High and the voltage value corresponding to the resonant current Ires is lower than the second reference voltage Vn.

In the LLC converter control circuit 100c according to the third example embodiment illustrated in FIG. 10, when the first driving signal VgH is High, the zero-crossing signal ZC may be Low, in other words, the resonant current Ires may be negative.

Accordingly, in the LLC converter control circuit 100c according to the third example embodiment, when the first driving signal VgH turns High from Low, the resonant current Ires may be negative and may thereafter increase to zero. Thus, the duration of time that the first signal Va is High may be shorter in the LLC converter control circuit 100e than in the LLC converter control circuit 100c.

If the respective on-widths of the second driving signal VgL and the first driving signal VgH become imbalanced, a DC voltage component of the resonant capacitor Cr may become different from a half of power of the input power supply Vin. This leads to a variation of an absolute value (|ΔIres/Δt|) of a slope of the resonant current Ires in the vicinity of a zero-crossing point.

Here, a duration of time that the second driving signal VgL is High will be denoted as time TonL, and a duration of time that the first driving signal VgH is High will be denoted as time TonH. If the time TonL is longer than the time TonH, the DC voltage component of the resonant capacitor Cr may become lower than Vin/2. One reason for this is that the low side switch QL may remain on for a longer duration of time than the high side switch QH, which results in a longer duration of discharging of the resonant capacitor Cr than a duration of charging of the resonant capacitor Cr.

Accordingly, an absolute value mL of the slope of the resonant current Ires when the low side switch QL is on may be smaller than an absolute value mH of the slope of the resonant current Ires when the high side switch QH is on.

Due to the absolute value mL being smaller than the absolute value mH, an output signal of the circuit NOR1 may turn Low at a more earlier point with respect to the zero-crossing point than an output signal of the circuit NOR2. This reduces a delay time and thus allows for control to cause the time TonL to be shorter than the time TonH, thereby helping to correct the imbalance.

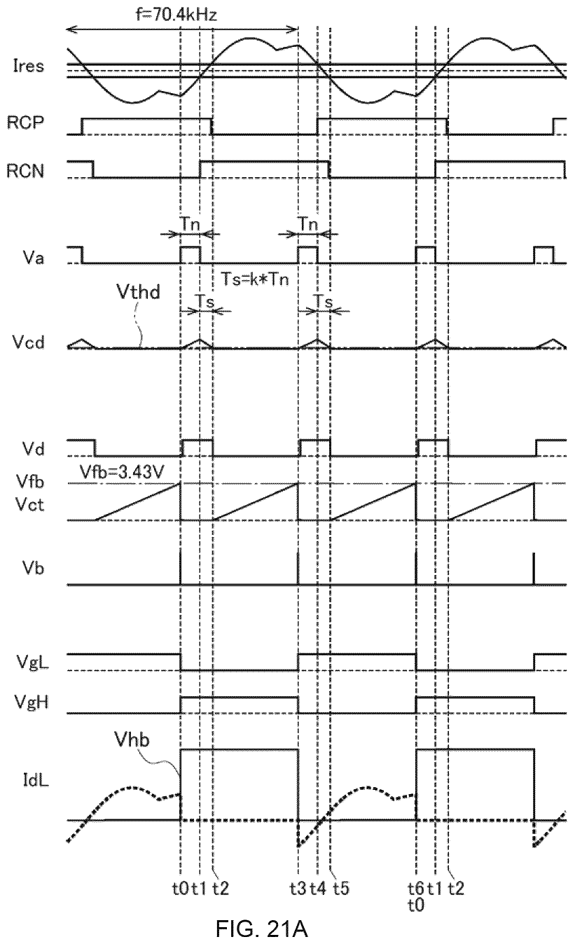

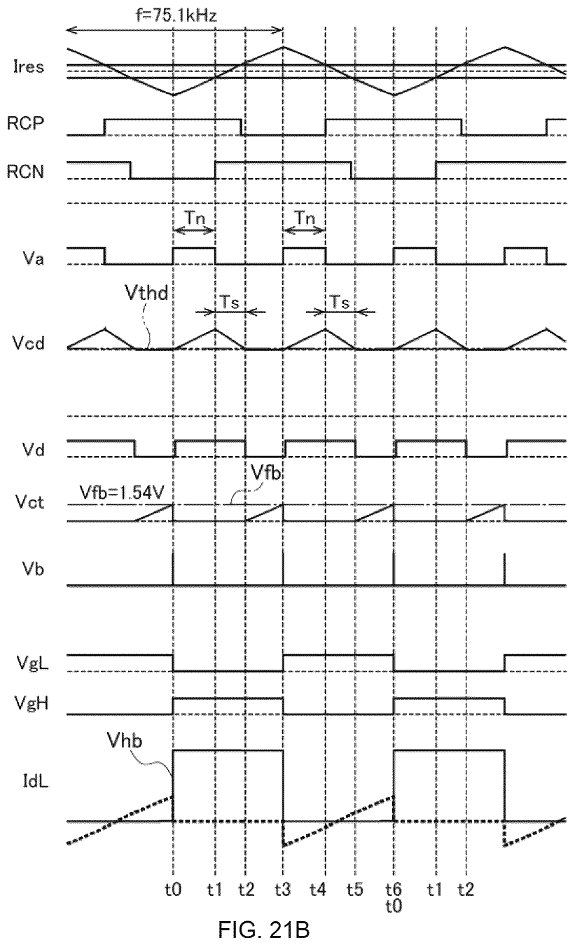

FIGS. 21A and 21B are diagrams for describing operations of the LLC converter control circuit 100e according to the fifth example embodiment with an output current of 10 A and an output current of 0.1 A, respectively.

As compared with the LLC converter control circuit 100c according to the third example embodiment, the LLC converter control circuit 100e according to the fifth example embodiment is different in the current detection circuit 110e and the synchronization signal generation circuit 120e. Accordingly, a description will be given here of a process of generating the delay signal Vd based on the first current detection result signal RCP and the second current detection result signal RCN.

Before the time t0, the first current detection result signal RCP may be High and the second current detection result signal RCN may be Low. Further, the second driving signal VgL may be High and the first driving signal VgH may be Low. Accordingly, the first signal Va may be Low, and the comparator CMP3 may output “Low”, due to the voltage Vcd of the capacitor Cd being lower than the threshold voltage Vthd. The delay signal Vd may thus be Low. The ramp voltage Vct while the capacitor Ct is under charging may be less than or equal to the feedback voltage Vfb.

At the time t0, the ramp voltage Vct of the capacitor Ct may become higher than the feedback voltage Vfb and the second signal Vb may thus turn High, which may cause the first driving signal VgH to turn High, and cause the second driving signal VgL to turn Low. Accordingly, the first signal Va may turn High from Low.

When the first signal Va turns High, the transistor Q11 may turn on, the transistors Q13 and Q14 may turn on, and the capacitor Cd may be charged with the current Icc1. When the voltage Vcd exceeds the threshold voltage Vthd, the comparator CMP3 may output “High”. This may cause the delay signal Vd to turn High.

When the delay signal Vd turns High, in the ramp voltage generation circuit 140e, the transistor Q4 may turn off, the transistor Q3 may turn on, and the capacitor Ct may be discharged. The second signal Vb to be outputted from the comparator circuit 150 may turn Low.

At the time t1, the voltage value corresponding to the resonant current Ires may become higher than the second reference voltage Vn, and accordingly, the second current detection result signal RCN may turn High from Low. This may cause the first signal Va to turn Low from High.

When the first signal Va turns Low, the transistor Q11 may turn off, and the transistor Q12 may turn on. Accordingly, the capacitor Cd may be discharged with the current Icc2, and the voltage Vcd may decrease in voltage value.

At the time t2, the voltage Vcd may become lower than the threshold voltage Vthd. Accordingly, the comparator CMP3 may output “Low”, and the delay signal Vd may thus turn Low.

When the delay signal Vd turns Low, in the ramp voltage generation circuit 140e, the transistor Q3 may turn off, the transistor Q4 may turn on, and the capacitor Ct may start being charged with the current Icc that flows based on the resistance of the resistor R2.

At the time t3, the ramp voltage Vct of the capacitor Ct may become higher than the feedback voltage Vfb and the second signal Vb may thus turn High, which may cause the first driving signal VgH to turn Low, and cause the second driving signal VgL to turn High. Further, the first signal Va may turn High from Low.

When the first signal Va turns High, the transistor Q11 may turn on, the transistors Q13 and Q14 may turn on, and the capacitor Cd may be charged with the current Icc1. When the voltage Vcd exceeds the threshold voltage Vthd, the comparator CMP3 may output “High”.

Thereafter, when the delay signal Vd turns High, in the ramp voltage generation circuit 140e, the transistor Q4 may turn off, the transistor Q3 may turn on, and the capacitor Ct may be discharged. As a result, the second signal Vb to be outputted from the comparator circuit 150 may turn Low.

At the time t4, the voltage value corresponding to the resonant current Ires may become lower than the first reference voltage Vp1, and accordingly, the first current detection result signal RCP may turn High from Low. This may cause the first signal Va to turn Low from High.

When the first signal Va turns Low, the transistor Q11 may turn off, and the transistor Q12 may turn on. Accordingly, the capacitor Cd may be discharged with the current Icc2, and the voltage Vcd may decrease in voltage value.

At the time t5, the voltage Vcd may become lower than the threshold voltage Vthd. Accordingly, the comparator CMP3 may output “Low”, and the delay signal Vd may thus turn Low.

When the delay signal Vd turns Low, in the ramp voltage generation circuit 140e, the transistor Q3 may turn off, the transistor Q4 may turn on, and the capacitor Ct may start being charged with the current Icc that flows based on the resistance of the resistor R2.

At the time t6, the ramp voltage Vct of the capacitor Ct may become higher than the feedback voltage Vfb and the second signal Vb may thus turn High, which may cause the second driving signal VgL to turn Low, and cause the first driving signal VgH to turn High. Further, the first signal Va may turn High from Low.

When the first signal Va turns High, the transistor Q11 may turn on, the transistors Q13 and Q14 may turn on, and the capacitor Cd may be charged with the current Icc1. When the voltage Vcd exceeds the threshold voltage Vthd, the comparator CMP3 may output “High”.

Thereafter, when the delay signal Vd turns High, in the ramp voltage generation circuit 140e, the transistor Q4 may turn off, the transistor Q3 may turn on, and the capacitor Ct may be discharged. As a result, the second signal Vb to be outputted from the comparator circuit 150 may turn Low.

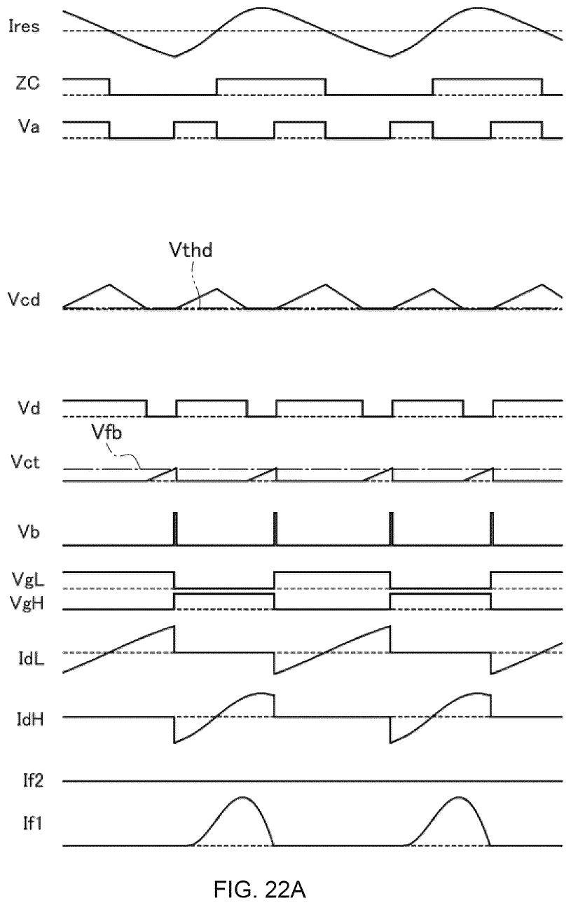

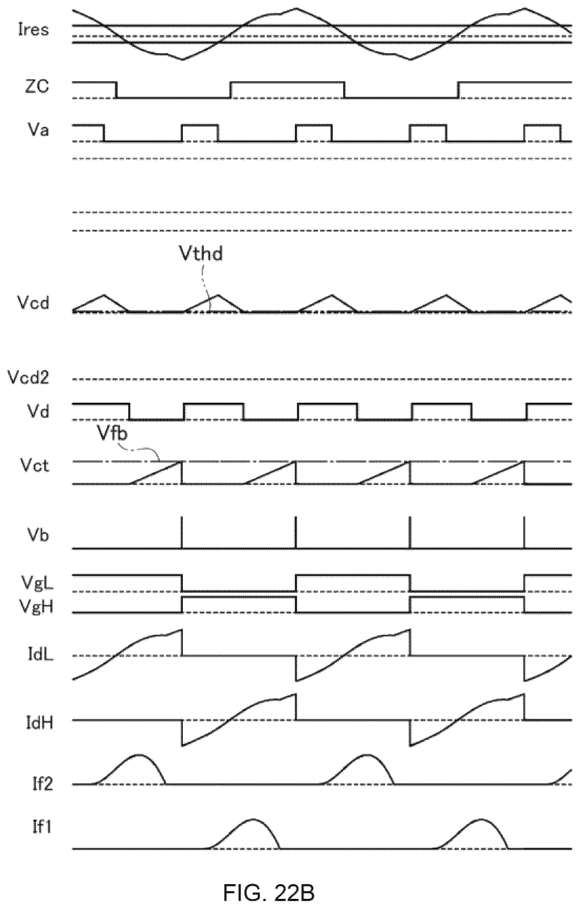

FIG. 22A is a diagram for describing the operation of the LLC converter control circuit 100c according to the third example embodiment during the imbalanced operating condition as a comparative example. FIG. 22B is a diagram for describing an operation example of the LLC converter control circuit 100e according to the fifth example embodiment. Note that FIGS. 22A and 22B each illustrate an example with an output current of 2 A.

In the operation example of the LLC converter control circuit 100c according to the third example embodiment illustrated in FIG. 22A, the first driving signal VgH may have an on-width of 6.04 μs and the second driving signal VgL may have an on-width of 6.98 μs. An imbalance may thus develop between the respective on-widths of the first driving signal VgH and the second driving signal VgL. This results in a rise in operating frequency. Accordingly, of the two rectifying diodes on the secondary side (i.e., the first diode Ds1 and the second diode Ds2), only a single rectifying diode may allow a current to flow through. Referring to FIG. 22A, only the current If1 may flow through the first diode Ds1, with no current If2 flowing through the second diode Ds2.

In contrast, the LLC converter control circuit 100e according to the fifth example embodiment helps to improve the imbalance between the on-widths during a light load condition, owing to the provision of the current detection circuit 110e and the synchronization signal generation circuit 120e illustrated in FIG. 20. In the example illustrated in FIG. 22B, the respective on-widths of the first driving signal VgH and the second driving signal VgL may both be 6.8732 μs. An improvement in the imbalance between the on-widths is thus achievable.

### Other Embodiments

Although some example embodiments of the disclosure have been described in detail with reference to the accompanying drawings, the disclosure is by no means limited by what is described in relation to such example embodiments above. Further, the components described hereinabove include those that may be readily conceived by a person skilled in the art and those that are substantially the same. Still further, any two or more of the configurations described hereinabove may be combined as appropriate. It is to be appreciated that various omissions, alterations, and modifications may be made to any of the configurations without departing from the gist of embodiments of the disclosure.

Features of the LLC converter control circuits 100a to 100e and the LLC converter 10 are described below.

In accordance with one embodiment of the disclosure, the LLC converter control circuits 100a to 100e are each configured to control the high side driving signal VgsH and the low side driving signal VgsL, based on the resonant current Ires flowing through the resonant circuit Re configured to resonate through alternate turning-on and turning-off of the high side switch QH and the low side switch QL. The high side driving signal VgsH is adapted to drive the high side switch QH. The low side driving signal VgsL is adapted to drive the low side switch QL. The LLC converter control circuits 100a to 100e each include corresponding one of the current detection circuits 110 and 110e. The current detection circuits 110 and 110e are each configured to perform detection of a current value of the resonant current Ires and output a result of the detection as the current detection result signal. The LLC converter control circuits 100a to 100e each further include corresponding one of the synchronization signal generation circuits 120, 120d1 to 120d4, and 120e. The synchronization signal generation circuits 120, 120d1 to 120d4, and 120e are each configured to generate the first signal Va, based on the first driving signal VgH and the current detection result signal. The first driving signal VgH is adapted to generate the high side driving signal VgsH. The LLC converter control circuits 100a to 100e further include the ramp voltage generation circuits 140a to 140e, respectively. The ramp voltage generation circuits 140a to 140e are each configured to generate, based on the first signal Va, the sawtooth ramp voltage having a slope determined in advance. The LLC converter control circuits 100a to 100e each further include the feedback voltage generation circuit 130 and the comparator circuit 150. The feedback voltage generation circuit 130 is configured to convert the feedback current Ifb of the LLC converter 10 into the feedback voltage Vfb and output the feedback voltage Vfb. The comparator circuit 150 is configured to generate the second signal Vb by performing a comparison between the feedback voltage Vfb and the sawtooth ramp voltage. The LLC converter control circuits 100a to 100e each further include the driving signal generation circuit 160. The driving signal generation circuit 160 is configured to generate the first driving signal VgH and the second driving signal VgL, based on the second signal Vb. The second driving signal VgL is adapted to generate the low side driving signal VgsL. The ramp voltage generation circuits 140a to 140e are each configured to generate the sawtooth ramp voltage to allow the amplitude of the sawtooth ramp voltage to decrease as the resonant current Ires decreases.

This configuration allows each of the LLC converter control circuits 100a to 100e to generate an appropriate sawtooth voltage even in a region where the output current is small. This helps to decrease the amplitude of the ramp voltage Vct during a light load condition, and to thereby achieve a decrease in circuit current for generating the sawtooth waveform. Accordingly, in the LLC converter 10 including any one of the LLC converter control circuits 100a to 100e, lowered power consumption of relevant one of the LLC converter control circuits 100a to 100e is achievable, which helps to improve efficiency during a light load condition.

In accordance with another embodiment of the disclosure, the current detection circuit 110 of each of the LLC converter control circuits 100a to 100d may be configured to output, as the current detection result signal, the zero-crossing signal ZC that is to be at a high level when the resonant current Ires is positive and that is to be at a low level when the resonant current Ires is negative.

This configuration helps to allow each of the LLC converter control circuits 100a to 100d to generate an appropriate sawtooth voltage in accordance with the resonant current Ires, which in turn helps to decrease the amplitude of the ramp voltage Vct during a light load condition, and to thereby achieve a decrease in circuit current for generating the sawtooth waveform. Accordingly, in the LLC converter 10 including any one of the LLC converter control circuits 100a to 100d, lowered power consumption of relevant one of the LLC converter control circuit 100a to 100d is achievable, which helps to improve efficiency during a light load condition.

In accordance with still another embodiment of the disclosure, the LLC converter control circuits 100b, 100c, and 100d may further include the delay circuits 180, 180c, and 180d, respectively. The delay circuits 180, 180c, and 180d may each be configured to output the delay signal Vd. The delay signal Vd is the first signal Va whose negative edge is delayed by a predetermined time. The ramp voltage generation circuits 140b to 140d may each be configured to generate the sawtooth ramp voltage, based on the delay signal Vd.

This configuration helps to allow each of the LLC converter control circuits 100b to 100d to suppress a rise in voltage during a light load condition, through the use of the delay time by which the first signal Va is to be delayed. In the LLC converter control circuits 100b to 100d, the suppressing of the rise in voltage helps to achieve lowered power consumption.

In accordance with yet another embodiment of the disclosure, in the LLC converter control circuit 100c, the predetermined time may be equal to k times the duration of time that the first signal Va is to be at the high level.

This configuration helps to allow the LLC converter control circuit 100c to more appropriately decrease the amplitude of the ramp voltage Vct during a light load condition, by delaying the first signal Va by the time equal to k times the duration of time that the first signal Va is to be at the high level. This helps to achieve a decrease in circuit current for generating the sawtooth waveform. Accordingly, in the LLC converter 10 including the LLC converter control circuit 100c, lowered power consumption of the LLC converter control circuit 100c is achievable, which helps to improve efficiency during a light load condition.

In accordance with a further embodiment of the disclosure, the synchronization signal generation circuits 120d1 to 120d4 in the respective LLC converter control circuits 100d may each be configured to generate the first signals Vac1, Vac2, Vad1, and Vad2, based on the first driving signal VgH, the second driving signal VgL, and the zero-crossing signal ZC, to allow the respective on-widths of the first driving signal VgH and the second driving signal VgL to be equal to each other.

This configuration allows each of the LLC converter control circuits 100d to improve any imbalance between the respective on-widths of the first driving signal VgH and the second driving signal VgL, which in turn helps to prevent an increase in effective current value.

In accordance with a still further embodiment of the disclosure, in the LLC converter control circuit 100e, the current detection circuit 110e may be configured to output the first current detection result signal RCP as the current detection result signal. The first current detection result signal RCP is to be at a high level when a value as a resultant of a conversion of the resonant current Ires into a voltage is lower than the first reference voltage Vp1 that is a predetermined positive voltage. The current detection circuit 110e may be further configured to output the second current detection result signal RCN as the current detection result signal. The second current detection result signal RCN is to be at a high level when the value as the resultant of the conversion of the resonant current Ires into the voltage is higher than the second reference voltage Vn that is a predetermined negative voltage and that is equal in absolute value to the first reference voltage Vp1. The synchronization signal generation circuit 120e may be configured to output the first signal Va that is to be at a high level when the first driving signal VgH is at a low level and the first current detection result signal RCP is at a low level. The synchronization signal generation circuit 120e may be configured to output the first signal Va that is to be at the high level when the second driving signal VgL is at a low level and the second current detection result signal RCN is at a low level.

This configuration helps to allow the LLC converter control circuit 100e to improve any imbalance between the respective on-widths of the first driving signal VgH and the second driving signal VgL, which in turn helps to prevent an increase in effective current value.

In accordance with a yet further embodiment of the disclosure, the LLC converter 10 includes any one of the LLC converter control circuits 100a to 100e described above, the input power supply Vin, and the half bridge circuit Hb. The half bridge circuit Hb includes the high side switch QH and the low side switch QL. The LLC converter 10 further includes the resonant circuit Re. The resonant circuit Re is coupled between the output HB of the half bridge circuit Hb and the ground GND, and includes the primary winding Np of the transformer T and the resonant capacitor Cr that are coupled in series to each other. The LLC converter 10 further includes the rectifying and smoothing circuit Rs, the output voltage detection circuit 200, and the resonant current detection circuit 300. The rectifying and smoothing circuit Rs includes the first diode Ds1, the second diode Ds2, and the output capacitor Co, and is configured to rectify and smooth the respective currents flowing through the secondary windings Ns1 and Ns2 of the transformer T. The output voltage detection circuit 200 is configured to detect the output voltage Vo. The resonant current detection circuit 300 is configured to detect the resonant current Ires flowing through the resonant circuit Re.

This configuration helps to allow the LLC converter 10 including any one of the LLC converter control circuits 100a to 100e to generate an appropriate sawtooth voltage even in a region where the output current is small. This in turn helps to allow the LLC converter 10 to decrease the amplitude of the ramp voltage Vct during a light load condition, and to thereby achieve a decrease in circuit current for generating the sawtooth waveform. Accordingly, in the LLC converter 10 including any one of the LLC converter control circuits 100a to 100e, lowered power consumption of relevant one of the LLC converter control circuit 100a to 100e is achievable, which helps to improve efficiency during a light load condition.

An embodiment of the disclosure may have any of the following configurations.

(1)

An LLC converter control circuit for an LLC converter, the LLC converter control circuit being configured to control a high side driving signal and a low side driving signal, based on a resonant current flowing through a resonant circuit configured to resonate through alternate turning-on and turning-off of a high side switch and a low side switch, the high side driving signal being adapted to drive the high side switch, the low side driving signal being adapted to drive the low side switch,
the LLC converter control circuit including:
a current detection circuit configured to perform detection of a current value of the resonant current and output a result of the detection as a current detection result signal;
a synchronization signal generation circuit configured to generate a first signal, based on a first driving signal and the current detection result signal, the first driving signal being adapted to generate the high side driving signal;
a ramp voltage generation circuit configured to generate, based on the first signal, sawtooth ramp voltage having a slope determined in advance;
a feedback voltage generation circuit configured to convert a feedback current of the LLC converter into a feedback voltage and output the feedback voltage;
a comparator circuit configured to generate a second signal by performing a comparison between the feedback voltage and the sawtooth ramp voltage; and
a driving signal generation circuit configured to generate the first driving signal and a second driving signal, based on the second signal, the second driving signal being adapted to generate the low side driving signal, in which
the ramp voltage generation circuit is configured to generate the sawtooth ramp voltage to allow an amplitude of the sawtooth ramp voltage to decrease as the resonant current decreases.
   (2)

The LLC converter control circuit according to (1), in which the current detection circuit is configured to output, as the current detection result signal, a zero-crossing signal that is to be at a high level when the resonant current is positive and that is to be at a low level when the resonant current is negative.

(3)

The LLC converter control circuit according to (2), further including a delay circuit configured to output a delay signal, the delay signal being the first signal whose negative edge is delayed by a predetermined time, in which
the ramp voltage generation circuit is configured to generate the sawtooth ramp voltage, based on the delay signal.
   (4)

The LLC converter control circuit according to (3), in which the predetermined time is equal to k times a duration of time that the first signal is to be at a high level.

(5)

The LLC converter control circuit according to (3), in which the synchronization signal generation circuit is configured to generate the first signal, based on the first driving signal, the second driving signal, and the zero-crossing signal, to allow respective on-widths of the first driving signal and the second driving signal to be equal to each other.

(6)

The LLC converter control circuit according to (1), in which
the current detection circuit is configured to output a first current detection result signal and a second current detection result signal, each as the current detection result signal, the first current detection result signal being to be at a high level when a value as a resultant of a conversion of the resonant current into a voltage is lower than a first reference voltage that is a predetermined positive voltage, the second current detection result signal being to be at a high level when the value as the resultant of the conversion of the resonant current into the voltage is higher than a second reference voltage that is a predetermined negative voltage and that is equal in absolute value to the first reference voltage, and
the synchronization signal generation circuit is configured to output the first signal that is to be at a high level when the first driving signal is at a low level and the first current detection result signal is at a low level, or when the second driving signal is at a low level and the second current detection result signal is at a low level.
   (7)

An LLC converter including:
the LLC converter control circuit according to any one of (1) to (6);
an input power supply;
a half bridge circuit including the high side switch and the low side switch;
the resonant circuit, the resonant circuit being coupled between an output of the half bridge circuit and a ground, and including a primary winding of a transformer and a resonant capacitor that are coupled in series to each other;
a rectifying and smoothing circuit including a first diode, a second diode, and an output capacitor, and configured to rectify and smooth a current flowing through a secondary winding of the transformer;
an output voltage detection circuit configured to detect an output voltage; and
a resonant current detection circuit configured to detect the resonant current flowing through the resonant circuit.

An LLC converter control circuit and an LLC converter according to at least one embodiment of the disclosure each make it possible to generate an appropriate sawtooth voltage even in a region where an output current is small.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The limitations in the claims are to be interpreted broadly based on the language employed in the claims and not limited to examples described in this specification or during the prosecution of the application, and the examples are to be construed as non-exclusive. The use of the terms first, second, etc. do not denote any order or importance, but rather the terms first, second, etc. are used to distinguish one element from another. The term “substantially” and its variants are defined as being largely but not necessarily wholly what is specified as understood by one of ordinary skill in the art. The term “disposed on/provided on/formed on” and its variants as used herein refer to elements disposed directly in contact with each other or indirectly by having intervening structures therebetween. Moreover, no element or component in this disclosure is intended to be dedicated to the public regardless of whether the element or component is explicitly recited in the following claims.

What is claimed is

1. An LLC converter control circuit for an LLC converter, the LLC converter control circuit being configured to control a high side driving signal and a low side driving signal, based on a resonant current flowing through a resonant circuit configured to resonate through alternate turning-on and turning-off of a high side switch and a low side switch, the high side driving signal being adapted to drive the high side switch, the low side driving signal being adapted to drive the low side switch,
the LLC converter control circuit comprising:
a current detection circuit configured to perform detection of a current value of the resonant current and output a result of the detection as a current detection result signal;
a synchronization signal generation circuit configured to generate a first signal, based on a first driving signal and the current detection result signal, the first driving signal being adapted to generate the high side driving signal;
a ramp voltage generation circuit configured to generate, based on the first signal, sawtooth ramp voltage having a slope determined in advance;
a feedback voltage generation circuit configured to convert a feedback current of the LLC converter into a feedback voltage and output the feedback voltage;
a comparator circuit configured to generate a second signal by performing a comparison between the feedback voltage and the sawtooth ramp voltage; and
a driving signal generation circuit configured to generate the first driving signal and a second driving signal, based on the second signal, the second driving signal being adapted to generate the low side driving signal, wherein
the ramp voltage generation circuit is configured to generate the sawtooth ramp voltage to allow an amplitude of the sawtooth ramp voltage to decrease as the resonant current decreases.

2. The LLC converter control circuit according to claim 1, wherein the current detection circuit is configured to output, as the current detection result signal, a zero-crossing signal that is to be at a high level when the resonant current is positive and that is to be at a low level when the resonant current is negative.

3. The LLC converter control circuit according to claim 2, further comprising a delay circuit configured to output a delay signal, the delay signal being the first signal whose negative edge is delayed by a predetermined time, wherein
the ramp voltage generation circuit is configured to generate the sawtooth ramp voltage, based on the delay signal.

4. The LLC converter control circuit according to claim 3, wherein the predetermined time is equal to k times a duration of time that the first signal is to be at a high level.

5. The LLC converter control circuit according to claim 3, wherein the synchronization signal generation circuit is configured to generate the first signal, based on the first driving signal, the second driving signal, and the zero-crossing signal, to allow respective on-widths of the first driving signal and the second driving signal to be equal to each other.

6. The LLC converter control circuit according to claim 1, wherein
the current detection circuit is configured to output a first current detection result signal and a second current detection result signal, each as the current detection result signal, the first current detection result signal being to be at a high level when a value as a resultant of a conversion of the resonant current into a voltage is lower than a first reference voltage that is a predetermined positive voltage, the second current detection result signal being to be at a high level when the value as the resultant of the conversion of the resonant current into the voltage is higher than a second reference voltage that is a predetermined negative voltage and that is equal in absolute value to the first reference voltage, and
the synchronization signal generation circuit is configured to output the first signal that is to be at a high level when the first driving signal is at a low level and the first current detection result signal is at a low level, or when the second driving signal is at a low level and the second current detection result signal is at a low level.

7. An LLC converter comprising:
the LLC converter control circuit according to claim 1;
an input power supply;
a half bridge circuit including the high side switch and the low side switch;
the resonant circuit, the resonant circuit being coupled between an output of the half bridge circuit and a ground, and including a primary winding of a transformer and a resonant capacitor that are coupled in series to each other;
a rectifying and smoothing circuit including a first diode, a second diode, and an output capacitor, and configured to rectify and smooth a current flowing through a secondary winding of the transformer;
an output voltage detection circuit configured to detect an output voltage; and
a resonant current detection circuit configured to detect the resonant current flowing through the resonant circuit.
